(19) United States
(12) Patent Application Publication
(10) Pub. No.: US 2014/0095968 A1
(43) Pub. Date: Apr. 3, 2014

(54) SYSTEMS AND METHODS FOR ELECTRONIC FORM CREATION AND DOCUMENT ASSEMBLY

(71) Applicant: Plutext Pty Ltd, Darlingotn Point NSW (AU)

(72) Inventor: Jason Brett Harrop, Darlington Point NSW (AU)

(73) Assignee: Plutext Pty Ltd, Darlington Point NSW (AU)

(21) Appl. No.: 14/039,555

(22) Filed: Sep. 27, 2013

(30) Foreign Application Priority Data
Oct. 3, 2012 (AU) 2012904303

(51) Int. Cl. G06F 17/24

(52) U.S. Cl. CPC G06F 17/243
USPC 715/222

(57) ABSTRACT

A computer-based method of creating a document assembly source document using a document creation application comprises providing one or more selection interface components within the document creation application, each selection interface component being operable by an author to create a variable content element within a current document. The author is able to select one of the selection interface components, and is then presented with one or more input components into which values of variable content configuration information are entered. Document assembly source control elements are then automatically created, corresponding with the variable content element and the variable control configuration information, and then associated with the current document. The document assembly source elements are adapted for generation of a document assembly content form which comprises separate data model and presentation sections. Simplified creation of source documents enables non-programmers, and other users without in-depth technical knowledge, to author their own document assembly source documents.

### CROSS REFERENCE TO RELATED APPLICATIONS

This application claims priority to Australian Patent Application No. 2012904303 filed Oct. 3, 2012.

### TECHNICAL FIELD

The present invention relates to the fields of electronic forms and document assembly, and in particular to an interactive document assembly system.

### BACKGROUND

### Document Assembly

Document assembly (sometimes also called document automation, document output or document production) refers to the generation of one or more instance documents from one or more source documents. A source document is a generic document, and additional information specific to the relevant circumstances is used in order to generate an instance document suitable for those circumstances from one or more source documents. This additional information can originate from a user and/or some other data source. Document assembly software has been developed for generating documents that typically contain significant amounts of common text or data and some amount of varying detail text or data. Document assembly software is useful because, where a suitable source document exists, it enables instance documents to be produced more efficiently than would be the case using standard office productivity software (for example, a word processor).

A form letter is perhaps the simplest and most familiar example of a source document, and can be used to generate instance letters for a number of recipients. An instance letter is typically generated from a single source document and addressee information, such as the addressee's first and last names, title, and address. More complex instance documents, such as legal or financial documents, can be generated from one or more source documents, based on information specific to the parties involved and the circumstances of their relationships.

Document assembly systems may produce word processing documents, and/or slide presentations or spreadsheets, or PDF files which combine elements of any of these.

A document assembly system provides two environments. The first is an authoring environment for creating and maintaining source documents. The second is a runtime environment for generating instance documents from those source documents. Persons interacting with the authoring environment are referred to as “authors”; persons interacting with the runtime environment are distinguished by being referred to as “users”.

A document assembly system preferably performs a number of basic functions. First, it determines, on the basis of data provided to it, which parts of a source document to include in or exclude from a resulting instance document. For example, a paragraph, sentence or phrase might only be included in a legal contract if there is a guarantor. The system might present a question “Will there be a guarantor?” to the user; other systems allow the user to directly select clauses for insertion. Second, the system can also include in the instance document text which is not present in the source document. For example, a date, an address, or where a user of the system enters a yearly rental, the amount calculated to be payable per calendar month. Third, it is desirable to be able to repeat a passage of text a specified number of times, but with different data inserted at certain points within the passage in each repetition.

In order to be able to provide these basic functions, a document assembly system stores (i) information as to which parts of the source document may be included or excluded from the instance document (“conditional material”), (ii) information as to the locations in the document in which additional text (“variables”) may be inserted, and (iii) information identifying the passage of text to be repeated, the number of times to repeat it, the data to be inserted into each repetition, and which data is to differ with each repetition (“repeats”).

This information, required by the runtime environment, is called the document assembly logic, or simply logic.

The data provided to the document assembly system may be provided by a user, or obtained by the system from some data source (or some combination of these). A system in which the user may be prompted to provide some data in order to create the instance document is an interactive document assembly system.

A source document is represented in a document assembly system in some document format. Common document formats include Office Open XML and the Open Document Format (ODF).

Office Open XML (also informally known as OOXML or OpenXML) is a zipped, XML-based file format developed by Microsoft for representing spreadsheets, charts, presentations and word processing documents. The Office Open XML specification was initially standardised by Ecma (as ECMA-376) and later by ISO and IEC (as ISO/IEC 29500). Starting with Microsoft Office 2007, the Office Open XML file formats have been the default target file format of Microsoft Office. Wordprocessing documents in the OpenXML file format (hereinafter “DOCX File Format”) typically have the file extension DOCX.

Some systems use Extensible Markup Language (XML) for their source documents (as distinct from the zipped XML-based approach found in standard DOCX File Format and ODF files), but these are less common. There are also systems which use the Microsoft Word binary format (DOC), or rich text format (RTF) for their source documents, but these are becoming obsolete.

As many business documents are in a Word format (increasingly DOCX File Format), and many authors familiar with Microsoft Word, it is highly desirable that the source document format be compatible with Microsoft Word, and that an environment for authoring the source document be available which is based around Microsoft Word. Still the authoring environments (even Word based ones) in commercially available document assembly systems are intimidating for most non-programmers. This is a barrier to widespread authoring of source documents.

Prior to the advent of the World Wide Web, document assembly systems tended to be desktop software, or client server systems (for example, institutions printing statements for large numbers of customers). Where the data is provided by a user, it is provided via electronic forms, and these are now likely to be presented via a web browser. In order for this to occur, the document assembly system has to be able to generate a suitable web form or forms. These forms can be complex.

First, some questions may only be relevant if the user answers earlier questions in a certain way. For example, if the user answers “yes” to “Do you have any children?”. It is desirable for the dependant question to pop-up immediately (i.e. in an AJAX fashion) without the need for a new web page to be fetched from the server. It is highly desirable that this user interface be able to be created, without the author of the source document having to explicitly specify which questions are to be asked, and which questions depend on others.

Second, it is desirable to be able to ensure the information entered is of a certain type (e.g. a number or a date), and possibly perform additional validation.

As a consequence, developing a good document assembly system web front-end is non-trivial, and there is considerable scope for improving how this is done.

Web-enabled document assembly run-time environments typically emit HTML forms from their server component. To understand the shortcomings of this approach, the background art in electronic forms is next described.

### Electronic Forms

XForms, the World Wide Web Consortium (W3C) standard for electronic forms, defines an XML format for the abstract specification of forms for the Web. An XForms model includes a definition of an abstract user interface, one or more data models and in-form validation and business logic. XForms models are intended to be hosted within a presentation language such as, for example, HyperText Markup Language (HTML) or Extensible HyperText Markup Language (XHTML). Depending upon the host language, implementations of the XForms model may be rendered on, and accessed using a range of systems including, but not limited to, personal computers, laptops, and pervasive devices such as tablets or mobile phones. Form controls are typically organized into pages and visually presented to end users.

An XForms-based electronic form document may include more advanced features, such as validating received data against XML schema data types, requiring certain data in certain user interface form fields, disabling input controls, changing sections of the form depending on circumstances, handling repeating data and responding to actions in real time rather than at submission time. Thus, XForms functionality may reduce or even eliminate the need for an application developer to program user interface handler scripts for managing the user interface appropriately for the application. Further information about XForms can be found within the XForms Specification entitled “XForms 1.0 Third Edition,” as published by The World Wide Web Consortium (W3C).

When an XForm is available for a user to complete, the user may retrieve the XForm from a server, or other location, and load the XForm. In this scenario the XForms functionality is implemented as an XForms processor installed on the user's computer, e.g., within a client computer. For example, an XForms plug-in executable may be installed to execute within a Web browser on the user's computer. Alternatively, the XForms processor may be partially or wholly implemented server side, and the data gathered from the user in some other way (for example, using an HTML form, or via a series of SMS interactions).

Adobe's XML Forms Architecture (XFA) provides a template-based grammar and a set of processing rules that allow businesses to build electronic forms. XFA divides the definition of the form into a set of functional areas. Each functional area is represented by an individual XML grammar The whole set of XFA grammars can be packaged inside a single XML document known as an XDP (XML Data Package). There is an XML grammar for the data held by fields in the form, and an XML grammar which defines/controls the presentation, calculations and interaction rules of the form (the template grammar). Though they are often packaged together, data and template are separate entities. An XFA processing application associates data with template fields by a data binding process described in the XFA specification (Adobe XML Forms Architecture (XFA) Specification).

InfoPath is a Microsoft product for creating and filling electronic forms. An author creates an InfoPath form template using the InfoPath Designer application. A form template is a file with an .xsn file name extension. The .xsn file defines the data structure, appearance, and behavior of finished forms. A form template consists of several files that have been compressed into one, including one or more XML Schema files, an XSL Transformation (XSLT) file for each view in the form, an XML file for the data that appears by default when a form is first opened, script files or managed code assemblies, and a form definition file, called Manifest.xsf (see “A beginner's guide to forms and form templates”, at http://office.microsoft.com/en-au/infopath-help/a-beginner-s-guide-to-forms-and-form-tempiates-HA001155963.aspx). As the author designs the form using the InfoPath Designer application, the application dynamically creates an XML schema describing the data the form will capture. Provided that the author chose to create a “browser compatible form template” and published the form, a user can then complete the form using an InfoPath client application, or a suitable web browser. The publishing step converts the InfoPath .xsn files to a format suitable for display in a web browser (typically solution modules, data and .aspx pages). When the user completes the form (using either the InfoPath client application, or a suitable web browser), the form data is captured as XML complying with the XML schema. The XML data model is separate from the user interface views; XSLT is used to support this structural independence.

Unlike HTML forms, XForms separates the data model(s) from the user interface, and binds the two together. Adobe's XML forms architecture shares this characteristic, as does Microsoft's Infopath. To distinguish these form architectures from HTML forms, they are referred to here as “MVC Forms”

Disclosed here is a way of using an MVC Forms system as part of an interactive document assembly system, so that the effort involved in developing and maintaining the web based front end can be significantly reduced. The prior art electronic form system Infopath generates an MVC Form from an XML schema; it contains an import wizard which can convert some Word form fields (“Convert a Word document to an InfoPath form template”, http://office.microsoft.com/en-us/infopath-help/conven-a-word-document-to-an-infopath-form-template-HA010115466.apx). To the inventor's knowledge, the system disclosed below is the first system which generates an MVC Form from the logic in a Word document. To the inventor's knowledge, the system disclosed here is the first in which MVC Forms are used as part of an interactive document assembly system.

Over time, an organization may create a number of forms using their chosen MVC Forms implementation (completely independently of any document assembly system). Also disclosed here is a method for generating an initial version of a source document for a document assembly system from an MVC Form, so that an author creating a source document can start with relevant logic already present.

It is desired to provide methods for authoring a source document for a document assembly system, an answer file structure for a document assembly system, and a method for providing an MVC Front End for a document assembly system, that ameliorate one or more of the above difficulties, or at least provide a useful alternative.

### SUMMARY

Embodiments of the present invention comprise systems, computer-implemented apparatus, methods and document/file formats for document assembly, wherein data is gathered from the user using an MVC Form, which allows existing third party MVC Form tools to be leveraged for the data gathering. According to embodiments of the invention, an MVC (‘model-view-controller’) form is a document/file configured to facilitate presentation and collection of information from a user, which comprises separate data model and presentation sections, i.e. which distinctly specifies a data processing model, and a user interface, for associated information content.

Methods and apparatus embodying the invention for authoring a source document suitable for generating an MVC Form are disclosed.

Methods and apparatus embodying the invention for generating an MVC Form from one or more electronic documents created within a word processing application program are disclosed.

Data formats embodying the invention, in tangible machine readable form (e.g. as stored in a memory device or on a recording medium such as a magnetic or optical disc) for a document assembly system, which is suitable for use with an MVC Form sub-system, and which facilitate an easy to use authoring environment, are also disclosed. The data formats may comprise reusable data components.

Methods and apparatus for generating a source document from an MVC Form are disclosed.

Methods and apparatus embodying the invention for transforming the data model of an MVC Form into an office document are disclosed.

In some embodiments of the invention an API may be provided, enabling access to methods and apparatus embodying a document assembly system according to the invention, which may include a method which returns an MVC form for a specified source document.

### BRIEF DESCRIPTION OF THE DRAWINGS

Embodiments of the present invention are hereinafter described, by way of example only, with reference to the accompanying drawings, wherein:

FIG. 1 illustrates an exemplary network-based system that may be used for the authoring and run-time components of the present invention.

FIG. 2 illustrates the body of program instructions embodying various software related features of the authoring environment of the present invention.

FIG. 3 is a flow chart depicting the steps performed by the run-time environment of the present invention.

FIG. 4 is a block diagram showing the principal parts of a source document.

FIG. 5 is an exemplary embodiment of the document surface in the authoring environment.

FIGS. 6 to 15 are screenshots depicting various aspects of the authoring environment of the present invention.

FIG. 16 is a flow chart depicting the steps involved in creating a piece of reusable content in the authoring environment.

FIG. 17 is a flow chart depicting the steps involved in reusing an existing piece of reusable content in the authoring environment.

FIG. 18 is a block diagram depicting a document set in one exemplary embodiment of the present invention.

FIG. 19 is a flow chart depicting the steps involved in generating an MVC Form from a source document in one exemplary embodiment of the present invention.

FIG. 20 is a flow chart depicting the steps involved in generating a source document from an MVC Form.

### BRIEF DESCRIPTION OF ANNEXURES

Annexure A is an XML schema for an exemplary embodiment of the Questions Part.

Annexure B is an XML schema for an exemplary embodiment of the XPaths Part.

Annexure C is an XML schema for an exemplary embodiment of the Conditions Part.

Annexure D is an XML schema for an exemplary embodiment of the Answers Part.

Annexure E is an example of an Answers Part.

Annexures F to H are an example of an MVC Form generated from a source document in one exemplary embodiment of the present invention.

### DETAILED DESCRIPTION OF ILLUSTRATIVE EMBODIMENTS

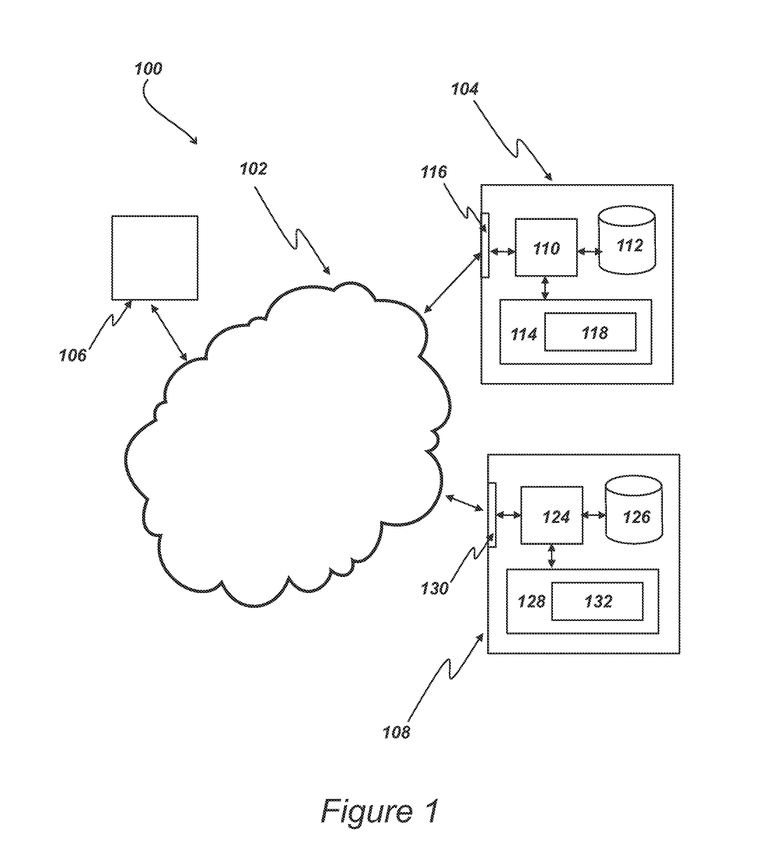

FIG. 1 illustrates schematically a network-based system 100 embodying the present invention. In the exemplary embodiment, the system 100 is interconnected via the Internet 102. However, the exemplary system 100 should not be considered to be limiting, since embodiments of the invention may be deployed via alternative data networks, such as private corporate networks, or implemented in a “standalone” form, wherein data is entered and retrieved via alternative means, such as storage media including hard disk drives, removable memory devices, and/or removable media such as CD-ROM or DVD-ROM discs. Deployment via the Internet is considered to be particularly advantageous, since it enables the benefits of the invention to be delivered remotely to a relatively large number of end-users.

The system 100 includes an authoring computer 104. The authoring component is installed and executes on the authoring computer 104. The authoring computer 104 includes at least one processor 110, which is interfaced, or otherwise associated, with a high-capacity, non-volatile memory/storage device 112, such as one or more hard-disk drives. The storage device 112 is used primarily to contain programs and data required for the operation of the computer 104, and for the implementation and operation of various software components implementing an embodiment of the present invention. The means by which this may be achieved are well-known in the art, and accordingly will not be discussed in detail herein.

The authoring computer 104 further includes an additional storage medium 114, typically being a suitable type of volatile memory, such as random access memory, for containing program instructions and transient data relating to the operation of the computer 104. Additionally, the computer 104 includes a network interface 116, accessible to the central processor 110, facilitating communications via the Internet 102.

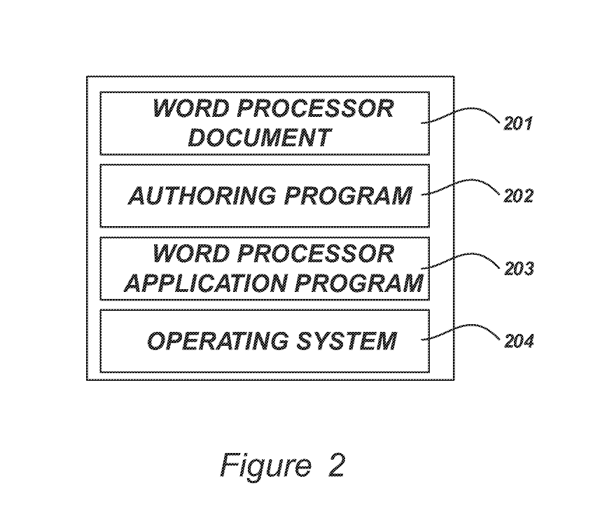

The memory device 114 contains a body of program instructions 118 embodying various software-implemented features of the present invention, as described in greater detail below with reference to FIG. 2. In general, these features include processing functions implementing a method of creating a document assembly source document from which an MVC Form can be generated.

The system 100 includes a user computer 106. The user computer participates in the system using widely available software applications, such as web browser software which is well-known in the art, and accordingly will not be discussed in detail herein.

For simplicity, components of the system 100 that are not required for the purposes of describing the present invention have been omitted from FIG. 1. For example, it will be appreciated that various firewalls and/or other intermediate communications devices, which would be included in any practical implementation of the system 100, have been omitted from the drawing.

The exemplary system 100 further includes a server computer 108, which is operated by or on behalf of a document provider, such as a law firm. The server computer 108 runs the document assembly server software, and has available to it source documents, which it is able to process in response to user requests.

The server computer 108 is accessible to both the authoring computer 104 and the user computer 106, via the Internet 102. The server computer 108 includes at least one processor 124, which is interfaced, or otherwise associated, with a high-capacity, non-volatile memory/storage device 126, such as one or more hard-disk drives. The storage device 126 is used primarily to contain programs and data required for the operation of the computer 108, and for the implementation and operation of various software components implementing an embodiment of the present invention. The means by which this may be achieved are well-known in the art, and accordingly will not be discussed in detail herein.

The server computer 108 further includes an additional storage medium 128, typically being a suitable type of volatile memory, such as random access memory, for containing program instructions and transient data relating to the operation of the computer 108. Additionally, the computer 108 includes a network interface 130, accessible to the central processor 124, facilitating communications via the Internet 102.

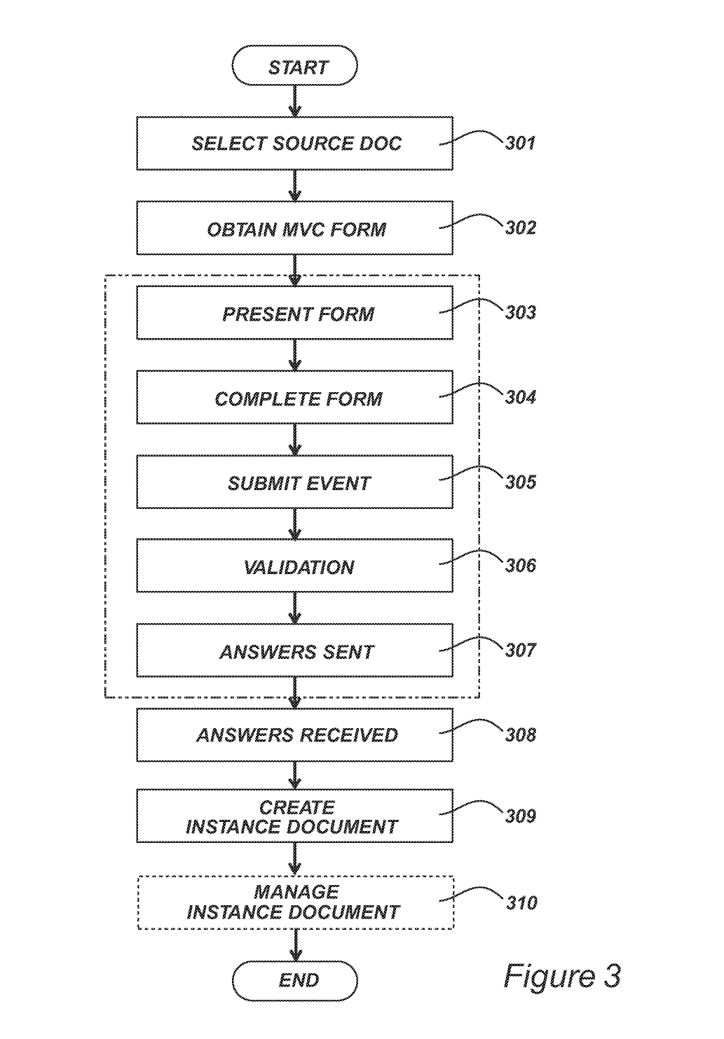

The memory device 128 contains a body of program instructions 132 embodying various software-implemented features of the present invention, as described in greater detail below with reference to FIG. 3. In general, these features include data analysis and processing functions implementing a method for generating an MVC Form from a document assembly source document. Additionally, a web server application is implemented, enabling the functions of the computer 108 to be accessed via the Internet 102 from the authoring computer 104 and/or the user computer 106, via widely available software applications, such as web browser software.

The present invention will be described in connection with a word processor, in particular Microsoft Word 2010, copyright Microsoft Corporation (hereinafter “Word”). To this end, some of the features of Word are utilized to implement some aspects of the embodiment of the invention described below. However, this is not to be construed as limiting the invention. Office productivity application programs such as word processors, presentation software, and spreadsheet programs from other manufacturers may be utilized to embody the various aspects of the present invention.

The present invention will be described in the context of a certain approach to designing a document assembly system which has been implemented by the author. This approach is presented first by way of introduction.

The task of authoring a source document is made easier if the author can be spared the effort of specifying explicitly which questions are to be asked when. This can be achieved if the conditional material and repeats in the source document are arranged in an express or implicit hierarchy. Such a hierarchy is provided in the source document format of many document assembly systems, whether the system uses a Microsoft Word compatible source document format, or not. For systems which use a Microsoft Word compatible source document format, the hierarchy can be provided by various means including by textual codes on the document surface, by field codes, by content controls, and by bookmarks.

Here, the use of content controls to represent variable text, conditional material and repeated material is described. Content controls are bounded regions in a document that serve as containers for specific types of content. Content controls (including rich text content controls) can be nested within a rich text content control, which provides a suitable hierarchy. Content controls are a feature of the DOCX File Format; Word supports various operations relating to content controls, both via its user interface, and programmatically. Content controls are supported by Microsoft Word, 2007 and later.

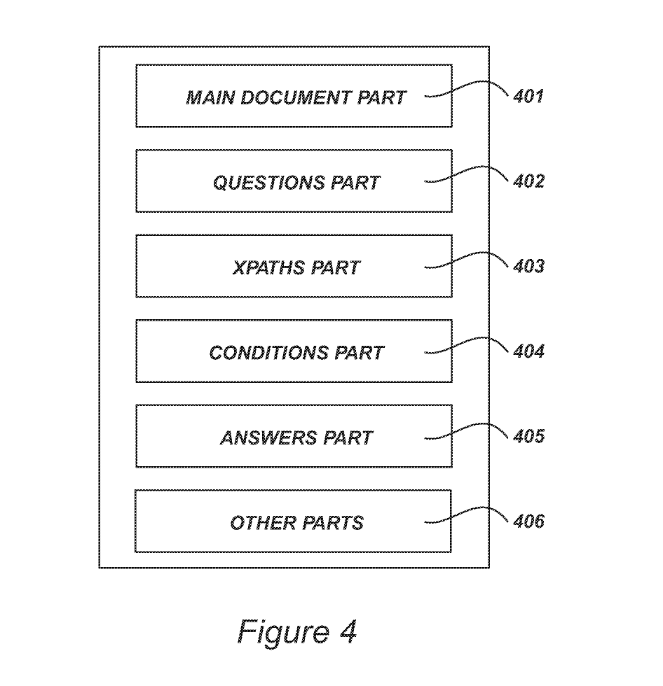

The DOCX File Format introduces a notion of “Custom XML Part”, which is a data store for an XML document, which can be saved as part of the DOCX file, as depicted in FIG. 4.

The DOCX File Format (and Word 2007 and 2010) supports binding a content control to a node in a Custom XML Part, using an XPath expression. This can be used by Word and other applications (for example, “docx4j”, https://github.com/plutext/docx4j) to insert the value of the XPath expression into the document at the position the content control is located.

There are several tools which developers can use to bind content controls to a Custom XML Part. With the Word Content Control Toolkit (http://dbe.codeplex.com/), you are shown the XML in the Custom XML Part and a list of content controls, and able to bind a node in the former to the latter. With the XML Mapping Task Pane for Word 2007/2010 (http://xmlmapping.codeplex.com/), you can drag and drop XML nodes onto the document surface to create content controls, or right click on an XML node to bind it to an existing content control. An XML Mapping Pane is included in Word 2013.

To support interactive document assembly, the system needs to be able to insert appropriate values into that Custom XML Part (hereinafter, “Answers Part”) 405, and to store the questions which will prompt the user for that data.

The DOCX File Format does not provide a specialised mechanism for storing the questions, but there are various ways this can be done. It is desirable to include all the logic within the DOCX File, so the source document can be moved between compatible document assembly systems, and continue to function without the need to move any external data, however, this should not be construed as limiting the invention described herein. The questions and answers could be stored outside the DOCX File, for example in a database. That said, using a Custom XML Part within the Docx File to store the questions is a good approach. It would be possible to store the questions in the same Custom XML Part as the answers, however separating the two is a better design.

A Custom XML Part suitable for this purpose is one (hereinafter, “Questions Part”) 402 matching the schema shown in Annexure A.

Another Custom XML Part (hereinafter, “XPaths Part”) 403 is used to associate a question in the Questions Part, with a slot for an answer in the Answers Part. A schema for the XPaths Part is shown in Annexure B.

For example, assume the Answers Part 405 contained:

<invoice>
<customer>
<name>Joe Bloggs</name>
</customer>
</invoice>

Notice that the Answers Part can contain arbitrary well-formed XML.

The Questions Part 402 could contain:

<questionnaire xmlns=“http://opendope.org/questions”>
<questions>

<question id=“q1”>
<text>Customer name?</text>
<response>

<free>
<format>text</format>
</free>

</response>
</question>

</questions>
</questionnaire>

The XPaths Part 403 could contain an entry:

<od:xpath id=“x1” questionID=“q1”>
<od:dataBinding
storeItemID=“{8B049945-9DFE-4726-9DE9-CF5691E53858}”

xpath=“/invoice[1]/customer[1]/name[1]”/>

</od:xpath>

An entry in the XPaths Part 403 associates an entry in the Answers Part 405, with a question in the Questions Part 402.

In the DOCX File Format (and Word's implementation of it), a content control has several properties including the tag property. The tag property allows you to associate an arbitrary string (of up to 64 characters in Microsoft Word 2007 and 2010) with the content control.

A content control's properties are contained in an sdtPr element. Continuing with the example:

<w:sdtPr>
<w:dataBinding w:storeItemID=“{8B049945-9DFE-4726-9DE9-

CF5691E53858}” w:xpath=“/invoice[1]/customer[1]/name[1]”/>

<w:tag w:val=“od:xpath=x1 ”/>
</w:sdtPr>

Here, the tag says the entry in the XPaths Part with @id=“x1” provides further information, including (via the questionID attribute on that entry) that the associated question in the Questions Part is the one which has @id=“q1”. It is the id attribute values which tie the corresponding entries in the various parts together.

Notice that the dataBinding element in the XPaths Part appears to be redundant (since it duplicates w:sdtPr/w:dataBinding).

According to the Open XML specification, there are certain content controls which can't be bound via a w:dataBinding element, most notably a rich text content control. For this reason, another approach is needed to bind such elements.

The XPath data binding for a rich text control could have been stored in the tag property, however the 64 character limitation makes this impractical. The XPaths Part was introduced to work around this limitation.

Microsoft has taken a different approach to work around this limitation. Word 2013 allows a rich text control to be bound via a dataBinding element in the http://schemas.microsoft.com/office/word/2012/wordml namespace, as described in “[MS-DOCX]: Word Extensions to the Office Open XML (.docx) File Format”.

The XPaths Part is also a convenient place to also store XPath expressions relating to conditions and repeats (both described below). It is for consistency with these that one might also include the data binding for a bound content control in the XPaths Part as well.

The DOCX File Format does not provide a specialised content control for conditional content. However, a tag can be used to specify whether the contents of a rich text content control are to be included in the instance document or not.

A further Custom XML Part (hereinafter termed the Conditions Part) 404 can be used to define the condition, and the tag points to that definition, for example:
<w:tag w:val=“od:condition=c5”/>

A schema for a Conditions Part is shown in Annexure C. As the schema makes clear, a condition is the value of an XPath expression with a Boolean result, or some Boolean combination thereof.

So a content control which is to indicate that its content is conditional material (hereinafter conditional content control), will point via its tag to a condition in the Conditions Part, which in turn will point to one or more entries in the XPaths Part, each of which is associated with a question in the Questions Part, and a slot in the Answers Part for the corresponding answer.

The DOCX File Format does not provide a specialised content control for repeating content. Such a content control is introduced by “[MS-DOCX] Word Extensions to the Office Open XML (.docx) File Format” and implemented in Word 2013.

In order to support repeating content without extending the DOCX File Format, a content control tag containing “od:repeat” is used. It is generally attached to a rich text content control, for example:
<w:tag w:val=“od:repeat=x2”/>

Od:repeat points to an entry in the XPaths Part 403, which in turn points to the element to be repeated. For example, if the Answers Part 405 contained:

<items>
<item>
<name>apples</name>
<price>$20</price>
</item>
<item>
<name>bananas</name>
<price>$30</price>
</item>
<item>
<name>cherries</name>
<price>$40</price>
</item>
<total>$90</total>
</items>

and you wanted a row in a table for each item, you'd wrap a rich text content control around the table row, and the tag would point at an XPaths Part entry:

<od:xpath id=“x2”>
<od:dataBinding xpath=“/items/item”/>
</od:xpath>

The approach to supporting questions, repeats and conditionals described above is documented in the OpenDoPE Conventions document “Sdt Content Control conventions for repeats & conditionals” (hereinafter OpenDoPE Conventions), previously prepared by the inventor, and available from www.opendope.org, which pages are hereby incorporated herein, in their entirety, by reference.

The source code for an authoring tool which supports same is available from http://opendope.codeplex.com/. That authoring tool is an add-in for Word 2007 or 2010. However, it is aimed at a developer audience, as it exposes XML in the user interface, and assumes familiarity with Xpath, and as such is still too intimidating for many potential authors, including most lawyers. A means is required to simplify the authoring experience, including by hiding any underlying JSON or XML from the author as they author a source document.

Having described by way of introduction an approach to designing a document assembly system which has been implemented by the inventor, the invention is described below.

Disclosed here is a data structure for the XML content in the Answers Part which facilitates both an easy to use authoring tool (also disclosed here), and the use of MVC Forms for the user interface component to get answers from the user for the relevant questions (also disclosed here).

In the embodiments described herein, content controls in conjunction with a Questions Part 402, Answers Part 405, XPaths Part 403, and Conditions Part 404, are used to represent variable text, conditional material and repeated material. During authoring, these are loaded into storage medium 114 where they are operated upon by the body of program instructions 118 comprising the authoring tool, described in more detail further below. When a user starts the process of generating an XForm from a source document, these are loaded into storage medium 128 where they are operated upon by the body of program instructions 132, described in more detail further below.

The use of content controls to arrange the conditional material and repeats in a hierarchy is not to be construed as limiting this invention. As noted above there are various other ways in which an express or implicit hierarchy can be represented.

In the embodiment of a data structure for the XML content described herein, the answer file has a structure described by the schema shown in Annexure D. In contrast to the OpenDoPE Conventions, the format of the Custom XML Part representing the answers is fixed; that is, the author cannot choose to use XML conforming to some other schema. This constraint serves two purposes. First, it makes it easier to offer an authoring environment in which the author need not be exposed to XML or JSON, which is important for ease of use. Secondly, it instantiates a novel pattern for repeating structures which work effectively in an MVC Forms sub-system.

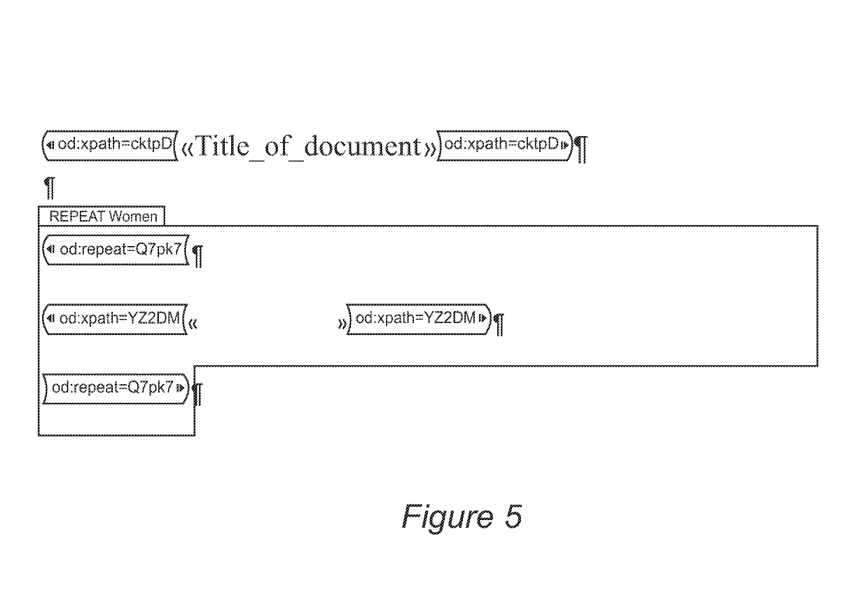

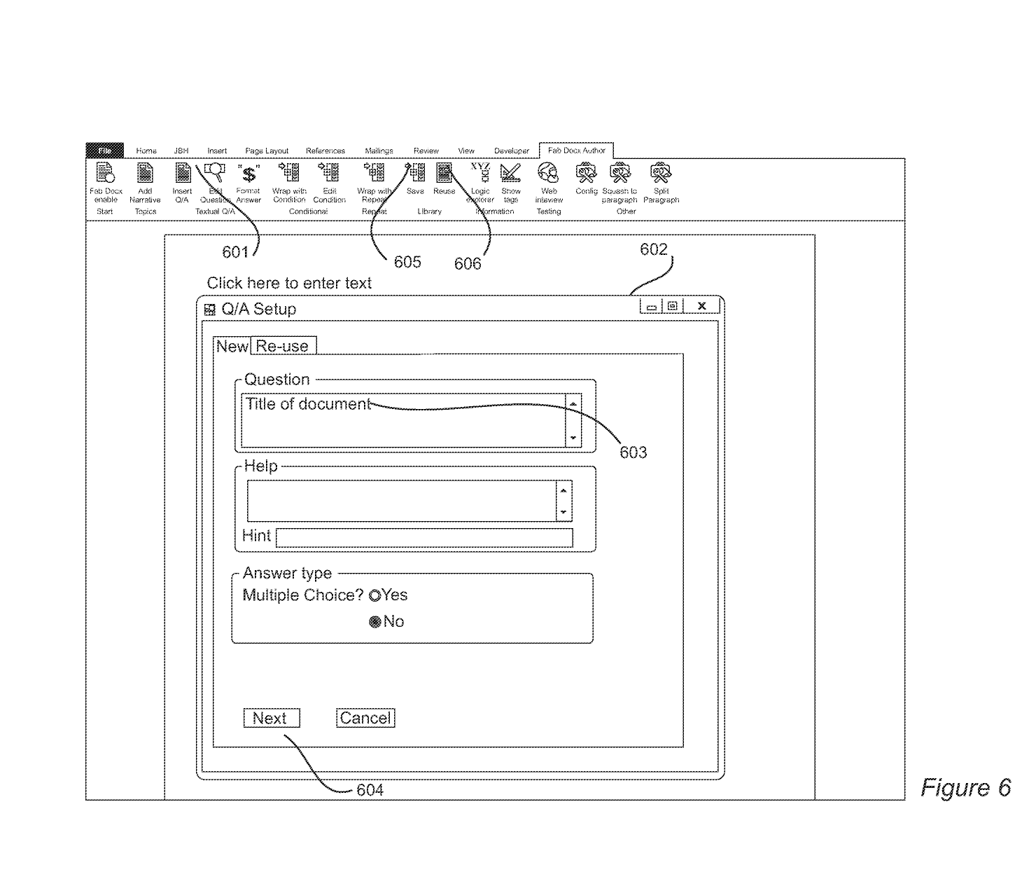

Consider for example the source document illustrated in FIG. 5 which is to have a title, and then for each of a number of women, the woman's name. The Main Document Part 401 corresponding to this would contain something like:

<w:document

xmlns:w=“http://schemas.openxmlformats.org/wordprocessingml/2006/
main” >

```
  <w:body>
    <w:sdt>
      <w:sdtPr>
        <w:alias w:val=“Title of document”/>
        <w:tag w:val=“od:xpath=cktpD”/>
        <w:id w:val=“289095091”/>
        <w:dataBinding
```

w:prefixMappings=“xmlns:oda=‘http://opendope.org/answers’”
w:xpath=“/oda:answers/oda:answer[@id=‘Title_of_document_nM’]”
w:storeItemID=“{183E9AF4-65AB-46DF-8044-944891825721}”/>

```
        <w:text w:multiLine=“1”/>
      </w:sdtPr>
      <w:sdtContent>
        <w:p>
          <w:pPr>
            <w:pStyle w:val=“Heading1”/>
          </w:pPr>
          <w:r>
            <w:t> [symbol]   Title_of_document [symbol]   </w:t>
          </w:r>
        </w:p>
      </w:sdtContent>
    </w:sdt>
    <w:p/>
    <w:sdt>
      <w:sdtPr>
        <w:alias w:val=“REPEAT Women”/>
        <w:tag w:val=“od:repeat=Q7pk7”/>
        <w:id w:val=“−1485702594”/>
      </w:sdtPr>
      <w:sdtContent>
        <w:p w:rsidR=“00740CC5” w:rsidRDefault=“00740CC5”
```

w:rsidP=“00740CC5”/>

```
        <w:sdt>
          <w:sdtPr>
            <w:alias w:val=“Woman's name?”/>
            <w:tag w:val=“od:xpath=YZ2DM”/>
            <w:id w:val=“1946430054”/>
            <w:dataBinding
```

w:prefixMappings=“xmlns:oda=‘http://opendope.org/answers’”
w:xpath=“/oda:answers/oda:repeat[@qref=‘Women_wF’]/oda:row[1]/
oda:answer[@id=‘Womans_name_LM’]” w:storeItemID=
“{183E9AF4-65AB-46DF-8044-944891825721}”/>

```
            <w:text w:multiLine=“1”/>
          </w:sdtPr>
          <w:sdtContent>
            <w:p>
              <w:r>
                <w:t> [symbol]   Womans_name [symbol]   </w:t>
              </w:r>
            </w:p>
          </w:sdtContent>
        </w:sdt>
        <w:p/>
      </w:sdtContent>
    </w:sdt>
  </w:body>
</w:document>
```

The XPaths Part 403, which uses the XPaths Part schema previously described:

<xpaths xmlns=“http://opendope.org/xpaths”>
<xpath type=“string” required=“false”

questionID=“Title_of_document_nM” id=“cktpD”>

<dataBinding xpath=“/oda:answers/oda:answer[@id=

‘Title_of_document_nM’]”
storeItemID=“{183E9AF4-65AB-46DF-8044-944891825721}”
prefixMappings=“xmlns:oda=‘http://opendope.org/answers’”/>

```
  </xpath>
  <xpath type=“nonNegativeInteger” questionID=“Women_wF”
  id=“Q7pk7”>
    <dataBinding xpath=“/oda:answers/oda:repeat[@qref=
```

‘Women_wF’]/oda:row” storeItemID=“{183E9AF4-65AB-46DF-
8044-944891825721}”
prefixMappings=“xmlns:oda=‘http://opendope.org/answers’”/>

```
  </xpath>
  <xpath type=“string” required=“false”
```

questionID=“Womans_name_LM” id=“YZ2DM”>

<dataBinding

xpath=“/oda:answers/oda:repeat[@qref=‘Women_wF’]/oda:row[1]/
oda:answer[@id=‘Womans_name_LM’]” storeItemID=
“{183E9AF4-65AB-46DF-8044-944891825721}”
prefixMappings=“xmlns:oda=‘http://opendope.org/answers’”/>

</xpath>
</xpaths>

The Questions Part 402, which uses the Questions Part schema previously described:

```
<questionnaire xmlns=“http://opendope.org/questions”>
  <questions>
    <question id=“Title_of_document_nM”>
      <text>Title of document</text>
      <response>
        <free/>
      </response>
    </question>
    <question id=“Women_wF” appearance=“compact”>
      <text>Women</text>
      <response>
        <fixed/>
      </response>
    </question>
    <question id=“Womans_name_LM”>
      <text>Woman's name?</text>
      <response>
        <free/>
      </response>
    </question>
  </questions>
</questionnaire>
```

The author is prompted for the question details as they insert each content control into the source document; a corresponding answer is also added automatically to an Answers Part matching the schema shown in Annexure D:

<answers xmlns=“http://opendope.org/answers”>
<oda:answer id=“Title_of_document_nM”

xmlns:oda=“http://opendope.org/answers”> [symbol] Title_of_document

[symbol]

```
</oda:answer>
  <oda:repeat qref=“Women_wF”
  xmlns.oda=“http://opendope.org/answers”>
    <oda:row>
      <oda:answer id=“Womans_name_LM”
```

xmlns:oda=“http://opendope.org/answers”> [symbol] Womans_name

[symbol]

```
</oda:answer>
    <oda:row>
  </oda:repeat>
</answers>
```

Notice the oda:repeat element, and its child oda:row element.

The content model for oda:repeat, as shown at or around line 18 of Annexure D, is zero or more oda:row elements.

Each oda:row element represents an instance of the data which varies with each repeat. That data can include variables (an oda:answer), and nested repeats (an oda:repeat element). An oda:answer which is not to be different in each iteration of a repeat is positioned higher up in the hierarchy. If it does not vary in any repeat, it is a child of the root element answers.

There is a correspondence between the hierarchical structure of the content controls, and the hierarchical structure of the Answers Part, which is explained more fully below.

The structure of the Answers Part instantiates a novel pattern which works effectively in the MVC Form sub-system described further below. It will be apparent to those skilled in the art that it is not the element names or namespaces which are of significance here, but rather, the arrangement of the repeating structures, the placement of variables (here, oda:answer elements) which are not to vary with each iteration of a repeat, and the hierarchical structure of the content controls.

During authoring, only a single oda:row element need be created for each oda:repeat element. At run-time, the user may cause 0 or more oda:row elements to be present (explained in greater detail further below).

An environment for authoring a source document will now be described further by reference to this example.

Where Word 2007 or later running on Microsoft Windows XP or later is used as the word processor application program 203, the authoring program 202 can be implemented as a Word 2007/2010 application level add-in for Word (as described in “Architecture of Application-Level Add-Ins” at http://msdn.microsoft.com/en-us/library/vstudio/bb386298), using Microsoft's Visual Studio Tools for Office (the Word Add-In authoring embodiment). In the Word Add-In authoring embodiment, these applications comprise the body of program instructions 118 embodying the software implemented aspects of the environment for authoring a source document.

In the Word Add-In authoring embodiment, in response to user input, the Windows operating system launches Microsoft Word with the authoring program 202 enabled. In this example, the source document 201 is empty except that it has been initialised with the structure shown in FIG. 4.

The authoring program 202 is event/callback driven. The user edits his/her document in Microsoft Word in the usual way, but when he/she does certain things (e.g. clicks a certain button on the ribbon presented by the authoring program), that triggers an event or callback which initiates a sequence of steps (as described herein).

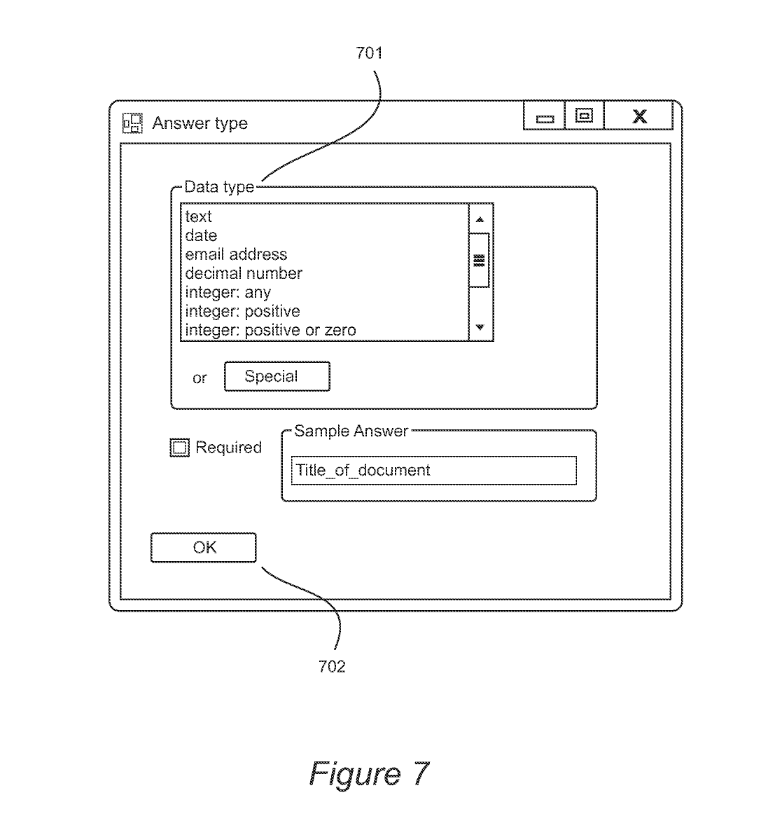

To add the oda:answer having id “Title_of_document”, program instructions implementing the callback procedure for the “Insert Q/A” button 601 cause the form 602 to appear when the author clicks the “Insert Q/A” button 601. The author may then type the question text at 603. Program instructions handling the click event which occurs when the author clicks the “Next” button 604, cause the form in FIG. 7 to appear, in which the author can select a data type 701. Program instructions handling the click event which occurs when the author clicks the “OK” button 702, insert a content control with w:alias value “Title of document” into the document, together with a corresponding Xpath entry, question entry, and answer entry, as described above.

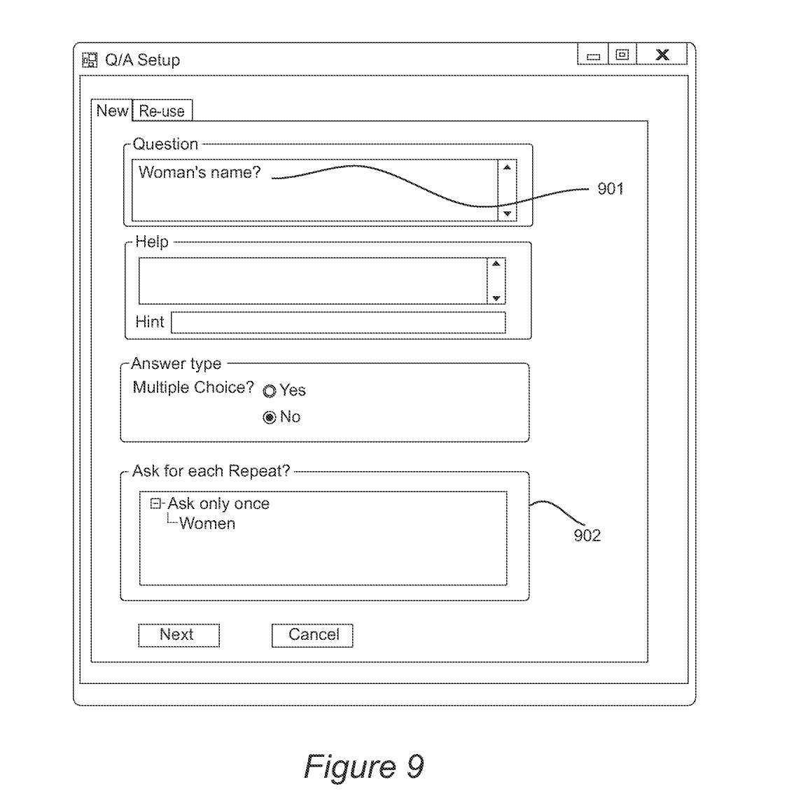

To add the oda:repeat for the women, program instructions implementing the callback procedure for the “Wrap with Repeat” button 801 cause the form 802 to appear when the author clicks the “Wrap with Repeat” button 801. The author may then type the repeat name at 803. Program instructions handling the click event which occurs when the author clicks the “OK” button 804, cause a content control with w:alias value “REPEAT Women” to be inserted into the document, together with a corresponding Xpath entry, question entry, and answer entry, as described above. The w:tag value “od:repeat=Q7pk7” points to the corresponding Xpath entry. In order for text corresponding to the woman's name to appear in instance documents, a variable is required in the source document. To insert this, the author again clicks the “Insert Q/A” button 601, whereupon the dialog box shown in FIG. 9 is displayed. As previously, the author types the question text at 901. Notice the “Ask for each Repeat” treeview at 902.

Recall from the background art that when repeating a passage of text a specified number of times, it is desirable to be able to specify which data is to differ with each repetition. To meet this requirement, an oda:answer which differs with each repeat appears in the corresponding oda:repeat structure (in the oda:row). If it does not differ with each repetition, it appears at a higher level. The authoring tool determines where to place the answer, by asking the user which repeat if any, the answer should vary with, using the treeview 902. Note that it only needs to do this if the content control being inserted is being inserted inside a repeat. The repeats the user may choose from are limited to those which are ancestors of the content control being inserted.

It is desirable that the authoring tool allow the user to insert the repeat content control, and a variable content control which is intended to appear within it, in either order.

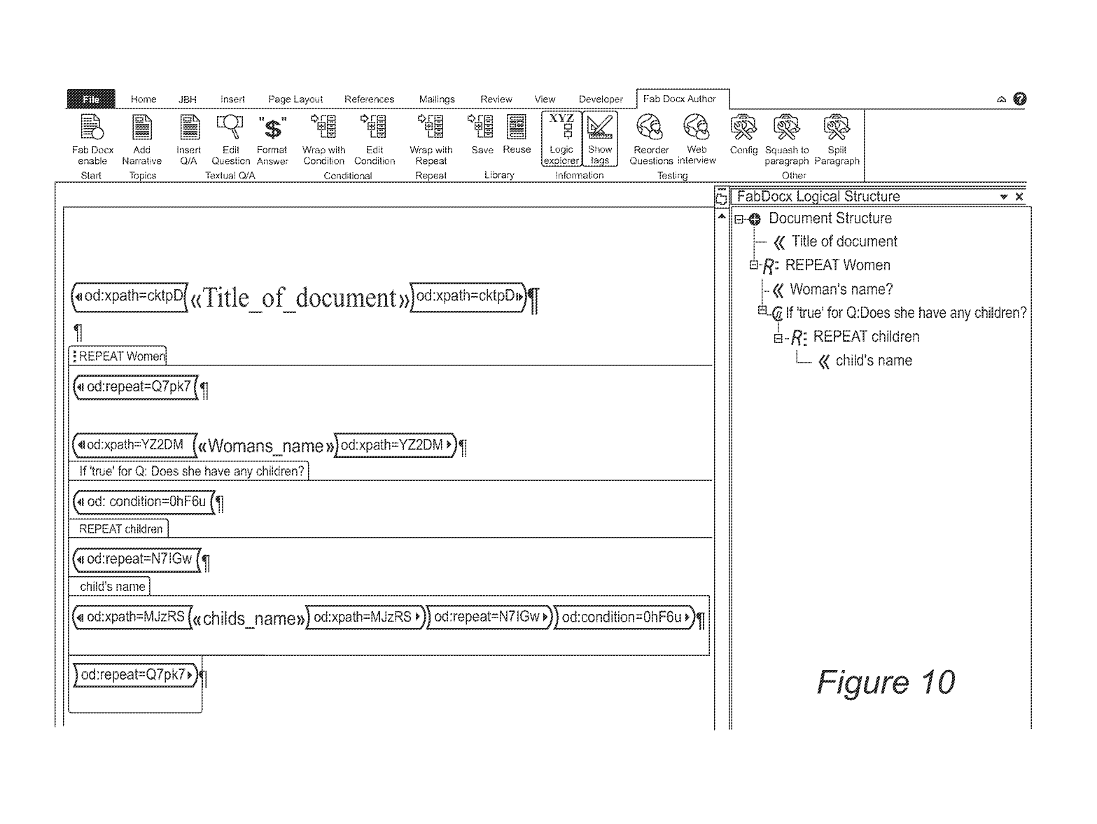

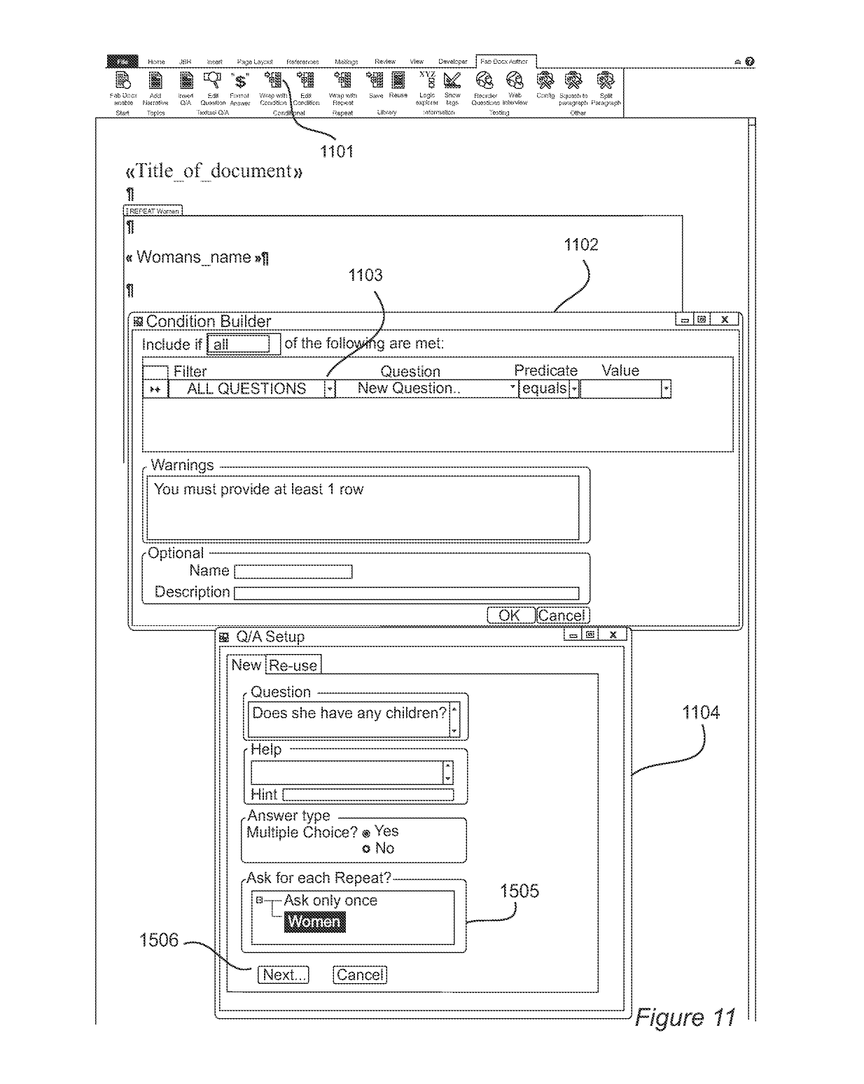

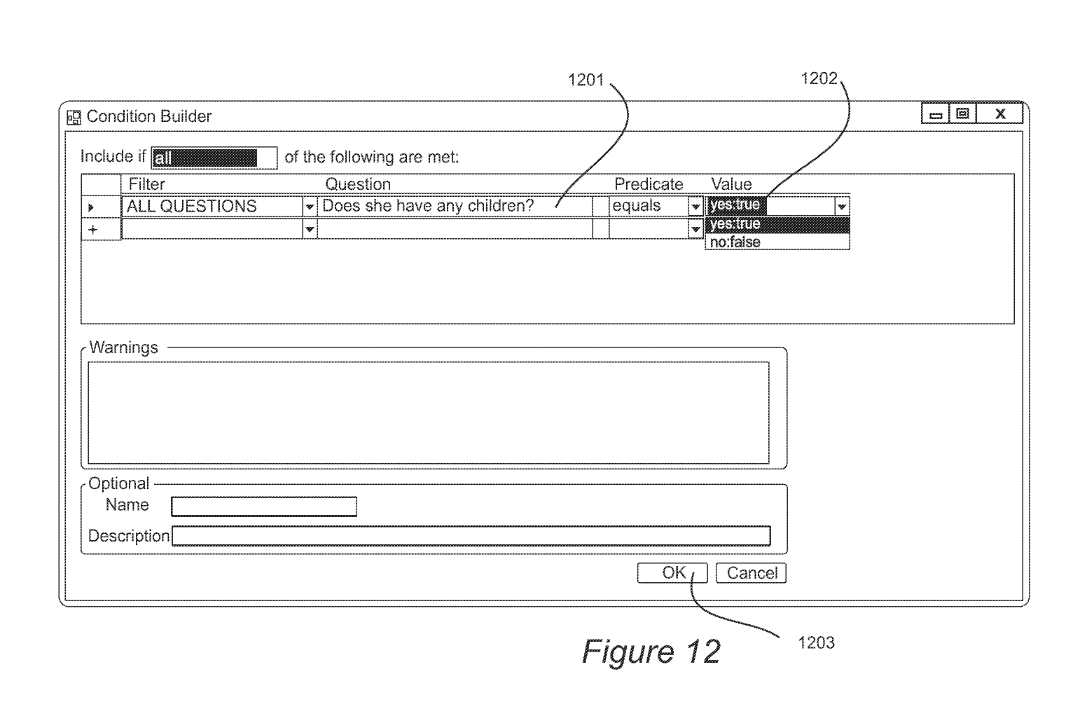

Extending this example, assume the user is to be asked whether the woman has any children, and if so for their names, which are to be listed. The author is aiming to create a source document with the structure shown in FIG. 10. In this example, the OpenXML for the repeat content control 1401 will ultimately be something like:

```
<w:sdt>
  <w:sdtPr>
    <w:alias w:val=“REPEAT Women”/>
    <w:tag w:val=“od:repeat=Q7pk7”/>
    <w:id w:val=“−1485702594”/>
  </w:sdtPr>
  <w:sdtEndPr/>
  <w:sdtContent>
    <w:p />
    <w:sdt>
      <w:sdtPr>
        <w:alias w:val=“Woman's name?”/>
        <w:tag w:val=“od:xpath=YZ2DM”/>
        <w:id w:val=“1946430054”/>
        <w:dataBinding
```

w:prefixMappings=“xmlns.oda=‘http://opendope.org/answers’”
w:xpath=“/oda:answers/oda:repeat[@qref=‘Women_wF’]/oda:row[1]/
oda:answer[@id=‘Womans_name_LM’]” w:storeItemID=
“{183E9AF4-65AB-46DF-8044-944891825721}”/>

```
        <w:text w:multiLine=“1”/>
      </w:sdtPr>
      <w:sdtEndPr/>
      <w:sdtContent>
        <w:p >
          <w:r>
            <w:t> [symbol]   Womans_name [symbol]   </w:t>
          </w:r>
        </w:p>
      </w:sdtContent>
    </w:sdt>
    <w:sdt>
      <w:sdtPr>
        <w:alias w:val=“If ‘true’ for Q: Does she have any
        children?”/>
        <w:tag w:val=“od:condition=OhF6u”/>
        <w:id w:val=“1932458076”/>
      </w:sdtPr>
      <w:sdtContent>
        <w:p />
        <w:sdt>
          <w:sdtPr>
            <w:alias w:val=“REPEAT children”/>
            <w:tag w:val=“od:repeat=N7IGw”/>
            <w:id w:val=“1287695316”/>
          </w:sdtPr>
          <w:sdtContent>
            <w:sdt>
              <w:sdtPr>
                <w:alias w:val=“child's name”/>
                <w:tag w:val=“od:xpath=MJzRS”/>
                <w:id w:val=“908655230”/>
                <w:dataBinding
```

w:prefixMappings=“xmlns.oda=‘http://opendope.org/answers’”
w:xpath=“/oda:answers/oda:repeat[@qref=‘Women_wF’]/oda:row[1]/
oda:answer[@id=‘childs_name_Px’]”
w:storeItemID=“ {183E9AF4-65AB-46DF-8044-944891825721}”/>

```
                <w:text w:multiLine=“1”/>
              </w:sdtPr>
              <w:sdtContent>
                <w:p>
                  <w:r>
                    <w:t> [symbol]   childs_name [symbol]   </w:t>
                  </w:r>
                </w:p>
              </w:sdtContent>
            </w:sdt>
          </w:sdtContent>
        </w:sdt>
      </w:sdtContent>
    </w:sdt>
    <w:p />
  </w:sdtContent>
</w:sdt>
```

There will be a Conditions Part:

<conditions xmlns=“http://opendope.org/conditions”>
<condition description=“If ‘true’ for Q: Does she have any

children?” id=“OhF6u” name=“”>

```
    <xpathref id=“jQB2e”/>
  </condition>
</conditions>
```

The XPaths Part will contain (storeItemID and prefixMappings attributes omitted for clarity) the following additional entries:

<xpath type=“string” required=“false”

questionID=“Womans_name_LM” id=“YZ2DM”>

<dataBinding

xpath=“/oda:answers/oda:repeat[@qref=‘Women_wF’]/
oda:row[1]/oda:answer[@id=‘Womans_name_LM’]” />

</xpath>
<xpath type=“string” required=“false”

questionID=“Does_she_have_any_children_QF” id=“CP11K”>

<dataBinding

xpath=“/oda:answers/oda:repeat[@qref=‘Women_wF’/oda:row[1]/
oda:answer[@id=‘Does_she_have_any_children_QF’]” />

</xpath>
<xpath id=“jQB2e”>
<dataBinding

xpath=“string(/oda:answers/oda:repeat[@qref=‘Women_wF’]/
oda:row[1]/oda:answer[@id =‘Does_she_have_any_children_QF’])=
‘true’” />

</xpath>
<xpath type=“string” required=“false”

questionID=“childs_name_Px” id=“MJzRS”>

<dataBinding

xpath=“/oda:answers/oda:repeat[@qref=‘Women_wF’]/oda:row[1]/
oda:repeat[@qref=‘children_tm’]/oda:row[1]/oda:answer[@id=
‘childs_name_Px’]” />

</xpath>
<xpath type=“nonNegativeInteger” questionID=“children_tm”
id=“N7IGw”>
<dataBinding

xpath=“/oda:answers/oda:repeat[@qref=‘Women_wF’]/oda:row[1]/
oda:repeat[@qref=‘children_tm’]/oda:row” />

</xpath>

The Questions Part will contain the following additional entries:

```
<question id=“Does_she_have_any_children_QF”
appearance=“compact”>
  <text>Does she have any children?</text>
  <response>
    <fixed canSelectMany=“false”>
      <item>
        <label>yes</label>
        <value>true</value>
      </item>
        <item>
          <label>no</label>
          <value>false</value>
        </item>
      </fixed>
    </response>
  </question>
  <question id=“childs_name_Px”>
    <text>child's name</text>
    <response>
      <free/>
    </response>
  </question>
  <question id=“children_tm” appearance=“compact”>
    <text>children</text>
    <response>
      <fixed/>
    </response>
  </question>
</questions>
```

The Answers Part will contain the data shown in Annexure E.

Working through this example, to make a list of child names which is conditional upon the woman having children, program instructions implementing the callback procedure for the “Wrap with Condition” button 1101 cause the form 1102 to appear when the author clicks the “Wrap with Condition” button 1101. This causes the dialog 1102 to appear, by which the author can construct a condition based on a question. In this case, the author wants to base the condition on a question “Does she have any children”, but that question has not yet been set up. So the author selects “New Question” 1103, whereupon program instructions handling the resulting selection event present form 1104, which the author then completes, ensuring at 1105 that the question is asked once for each woman. When the user clicks the “Next” button 1106 program instructions handling the resulting click event present the answer type form as shown in FIG. 7, and after completing this, the author is returned to the condition dialog 1102, from which the author can now select the question just added 1201. The author selects value ‘true’ (labelled ‘yes’) at 1202, and presses the “OK” button 1203, whereupon program instructions cause a conditional content control to be inserted into the document, and a new condition added to the Conditions Part, which points to a new entry in the XPaths Part, which is associated with the relevant question and answer in the questions and Answers Parts respectively. The conditional content control is given a w:tag pointing at the new condition.

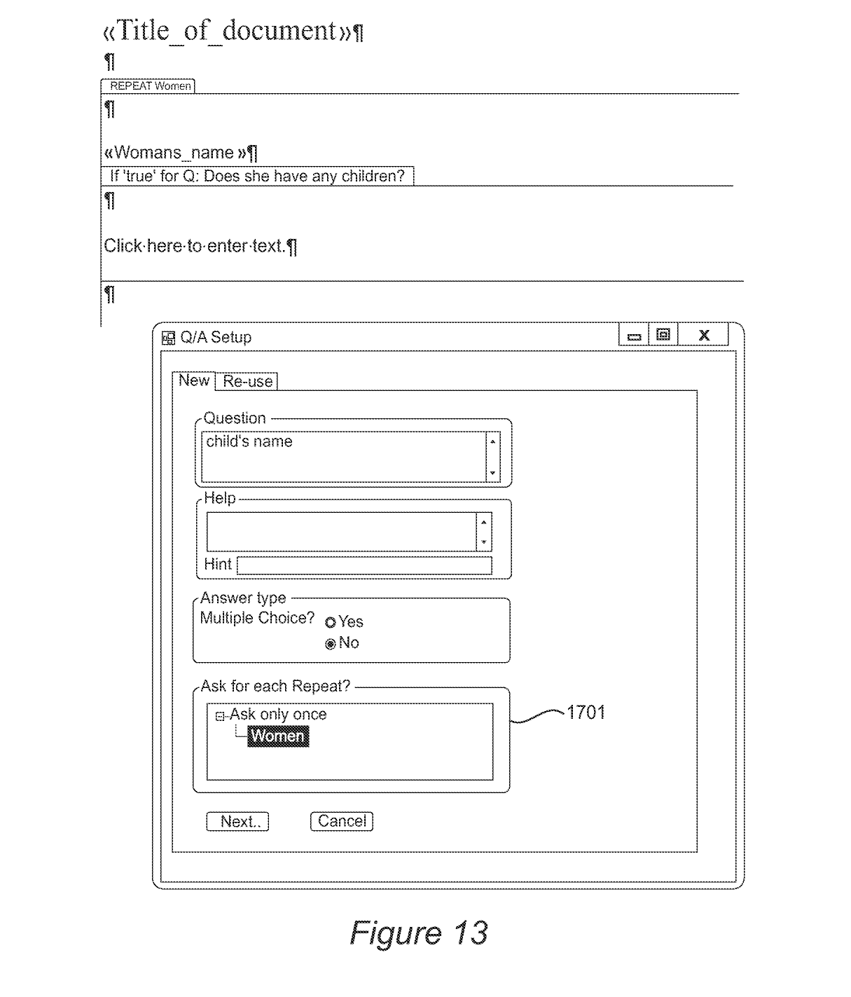

Suppose the author adds a variable asking for the child's name (i.e. before adding a repeat), as shown in FIG. 13. The author is not given the choice at 1301 to vary the child's name for each of a woman's children, as that repeat does not yet exist.

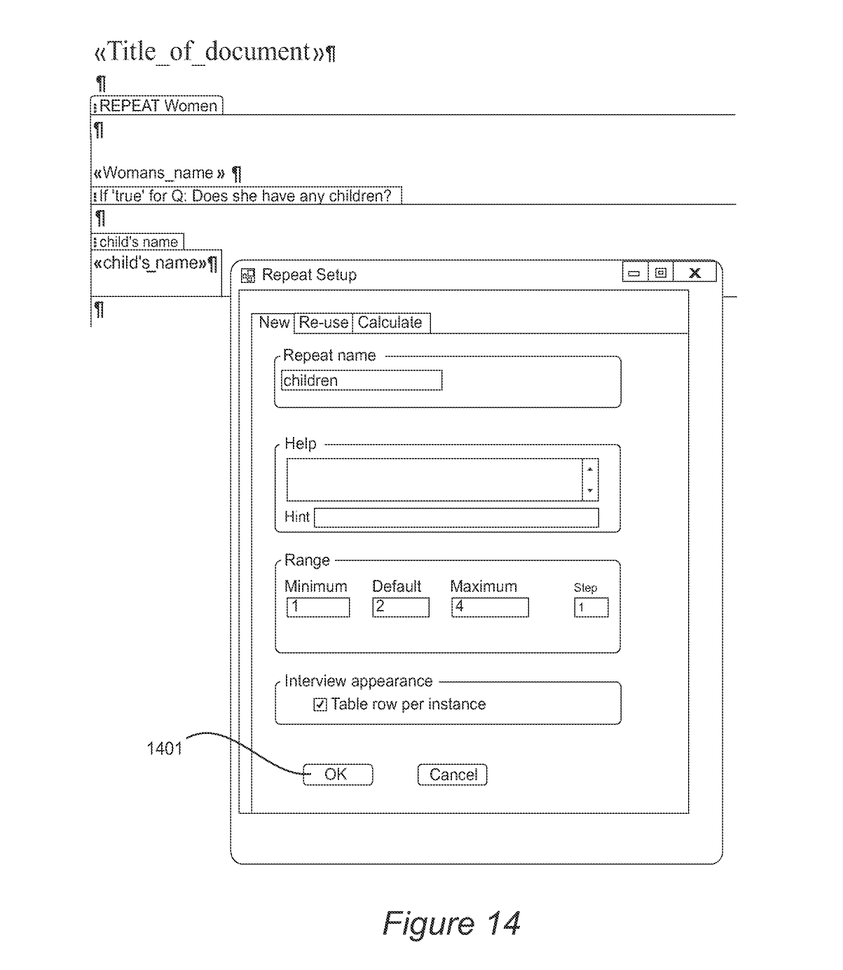

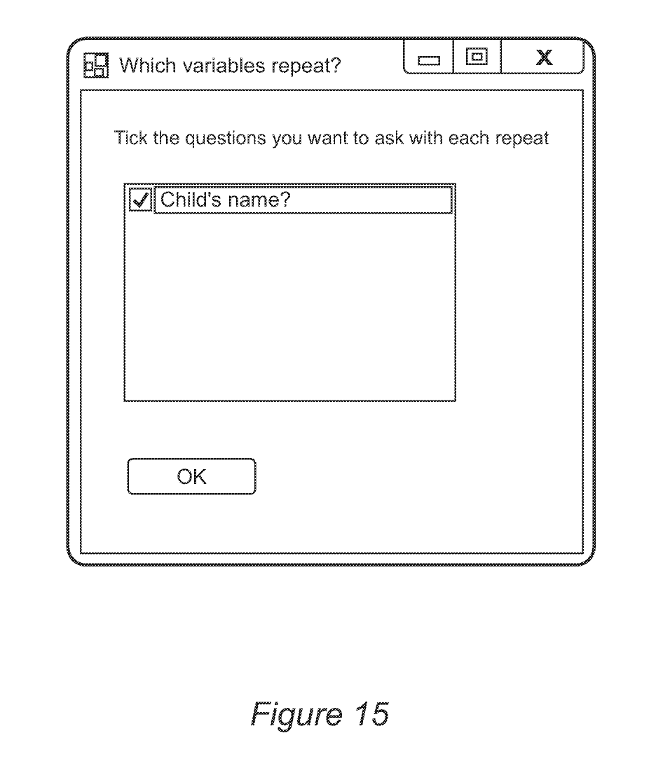

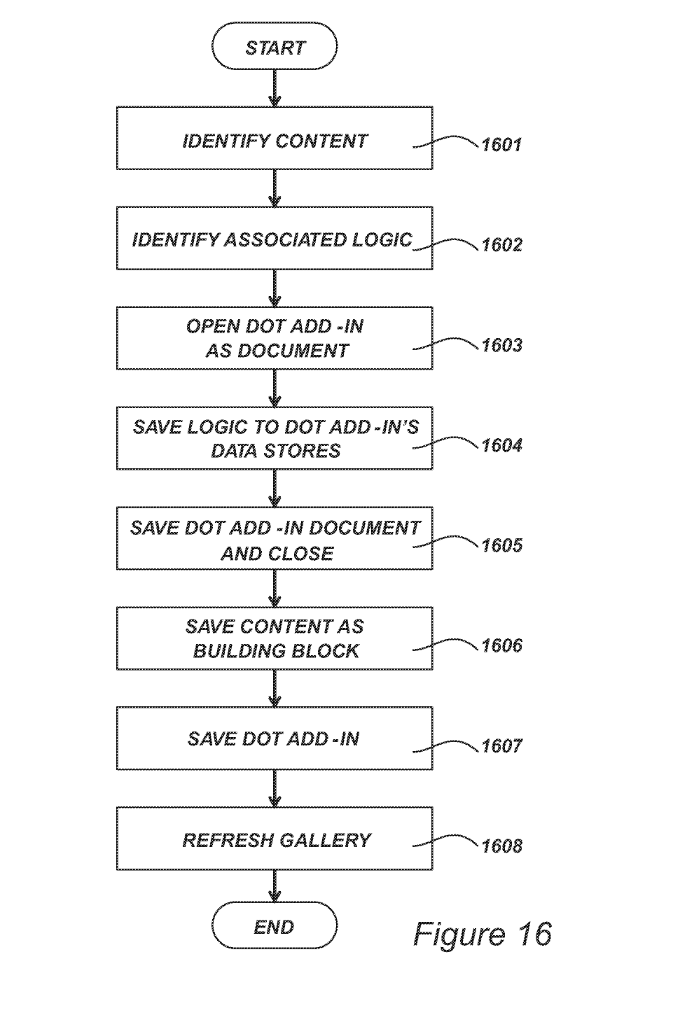

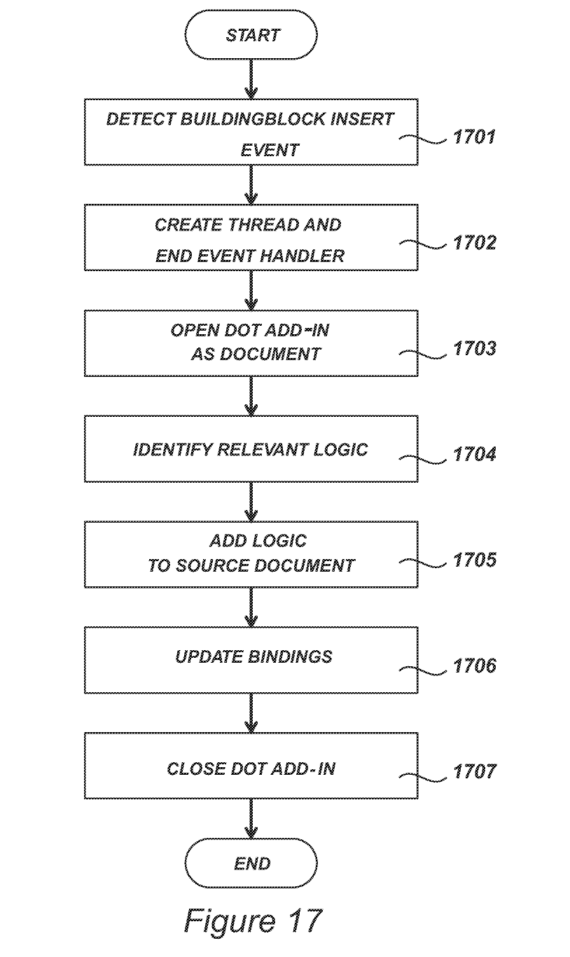

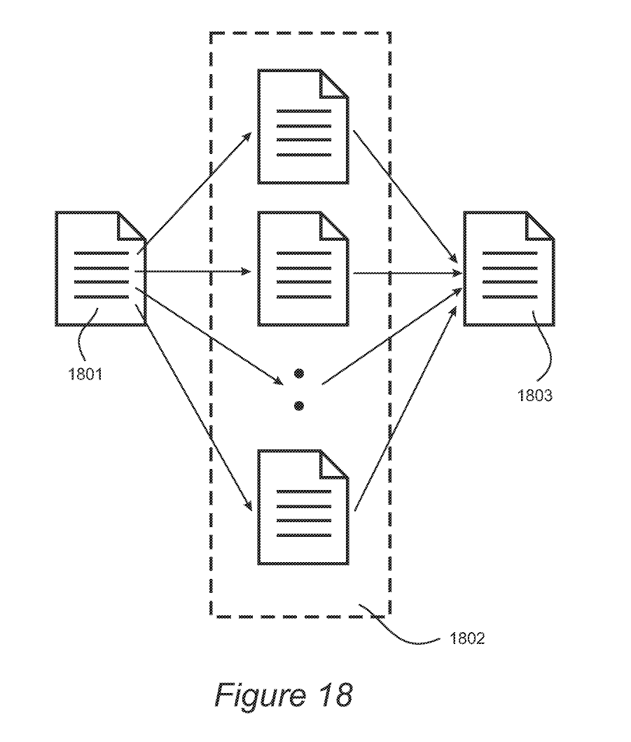

If such a repeat is then added (wrapping the child's name variable content control), as shown in FIG. 14, when the author presses the “OK” button 1401, program instructions handling the resulting click event cause the dialog in FIG. 15 to appear. This dialog shows the questions which are eligible to be made to vary in the repeat which is being added. In this case, the question “Child's name” is ticked, since the author wants to prompt the user for the child's name for each of a woman's children. Notice how, in Annexure E, the answer specifying the child's name (at around line 16) repeats for each child (at around line 14), for each woman (at around line 7).

An author is allowed to use a variable binding, condition or repeat more than once in a document. However, special rules apply if a variable varies in a repeat. If a variable varies in a repeat (i.e. its oda:answer is within the oda:repeat element), it can't be used outside that repeat (i.e. a content control using it can't appear outside the corresponding repeat content control).

Similarly, if the content control associated with a repeat has a repeat ancestor, it can only be used multiple times in content controls within that repeat ancestor.

A similar rule applies to conditions. If any of the answers used in that condition vary in a repeat, that condition may only be used in that repeat.

The authoring tool enforces these rules if a user attempts to move a content control (cut/paste), or copy it (copy/paste). This is done by trapping the ContentControlAfterAdd event.

Thus it can be seen that the organisation of oda:repeat and oda:answer elements in the hierarchical structure of the Answers Part imposes constraints on the possible arrangements of content controls. In another embodiment, when the user moves (cut/paste) or copies (copy/paste) a content control, the authoring tool would reposition oda:repeat and oda:answer elements so that they are consistent with the re-arrangement of content controls. In cases where this cannot be done, it would undo the user's change.

Once an author has set up some content containing variables, conditional text, and/or repeating text (“reusable content”), it is convenient to be able to re-use that content elsewhere in the document, or in some other document.

In the Word Add-In authoring embodiment, Microsoft Word's building block feature is used, to store such content in a gallery in a DOT Add-In accessible to the user's Word installation (see “Custom Document Templates”, http://msdn.microsoft.com/en-us/library/office/aa164937(v=office.10).aspx). To save content for re-use, the author selects the content, then presses the “Save” button 605. The selection is stored as a range 1601.

The Word programming API offers convenient methods to store textual content (including content controls) in a glossary document in an attached DOT Add-In. However, it is also necessary to store with the reusable content, the portions of the Answers Part, the XPaths Part, the Questions Part, and the Conditions Part which are associated with the reusable content. At 1602, the relevant portions of those parts are identified; the relevant portions being any logic used directly or indirectly in the identified content 1601. At 1603, the Word.Template object representing the DOT Add-In is opened as a Word.Document, using the OpenAsDocument method. At 1604, the relevant portions of those parts are copied into the corresponding Custom XML Parts in the DOT Add-In, at which point 1605 this Word.Document object can be saved and closed. At 1606, the author's selection is saved to the DOT Add-In, using BuildingBlockEntries.Add. At 1607 the DOT Add-In is saved and at 1608 the gallery refreshed so that the added content will appear.

The case where the reusable content contains content from within a repeat content control, but not the repeat content control itself has to be considered and handled appropriately. There is an issue if any variable in the reusable content varies in the repeat. There are three ways to this can be handled. First, the variable can be altered so that it does not vary in the repeat; second, the selection can be extended to include the repeat content control; or third, the operation can be cancelled.

Another problem which may arise is an ID collision. This will occur if any of the ids in the relevant portions of those parts have the same values as entries already present in the Custom XML Parts in the DOT Add-In. A simple way to handle this is to check whether an ID collision will occur, and if so, alter the IDs on the incoming objects.

In order to reuse reusable content from the gallery, program instructions associate the author's click on the “Reuse” button 606 in the Word user interface with a custom gallery (for example, idMso ‘CustomGallery1’) and display that gallery, from which the author selects the content they wish to reuse. Program instructions forming part of Word will insert the content into the author's document, but will not bring with it the relevant portions of the Custom XML Parts. To do this, the authoring add-in includes program instructions providing an event handler which responds to the BuildingBlockInsert event 1701, with the objective of copying the relevant logic from the DOT Add-In to the source document. This must be done in a separate thread 1702, or using a timer, since Word does not permit it to be done from within the event handler itself. To copy the logic across, at 1703 the add-in is opened as a Word.Document, using the OpenAsDocument method. At 1704, the relevant logic is identified, by looking at what is used in the content range being inserted, then at 1705 the logic is added (if not already present) to the source document, adjusting the storeItemIDs as necessary in the XPaths Part. At 1706, the storeItemIDs are updated in any bound content controls being inserted, to match the storeItemIDs in the source document. Finally at 1707, the Word.Document object is closed.

Where the reusable content is being copied into a repeat content control the relevant logic by default would not vary with that repeat. In one embodiment the user would be prompted whether each variable should vary with that repeat or some ancestor repeat. If the user indicates that a variable should vary with one of these repeats, then its answer would be moved into the appropriate oda:row, and its XPaths Part entry adjusted accordingly.

It is convenient for a document assembly system to be able to use the same answers across one or more documents, so that for example, the same information can be used in a cover letter and an agreement. To make this work, two things are required: (1) a way of defining the documents which are to share logic (the “document set”), and (2) a mechanism for sharing the logic.

In the Word Add-In Authoring embodiment, a DOT Add-In 1803 is created and attached to each document in the document set 1802. The shared logic is stored in this DOT Add-In. In the Word Add-In Authoring embodiment, the individual documents do not have their own Custom XML Parts, but rather, store all logic in this shared DOT ADD-In. In an alternative embodiment, the individual documents have their own Custom XML Parts, and a mechanism is included which makes available to the other documents any logic which is to be shared.

In the Word Add-In Authoring embodiment, the documents included in the document set are identified in a document 1801 which exists solely for this purpose. The document 1801 includes, for each document in the document set 1802, a content control having an OpenDoPE “component” tag (“component content control”):

<w:sdtPr>
<w:tag w:val=“od:component=comp1”/>
</w:sdtPr>

The URL of the docx to be inserted is specified in the components Custom XML Part:

<components xmlns=“http://opendope.org/components”>
<component id=“comp1” url=“http://www.foo.com/component-

subdoc.docx”/>

</components>

In the Word Add-In Authoring embodiment, a document can be made optional, by wrapping the component content control with a conditional content control.

In the Word Add-In Authoring embodiment, the DOT Add-In 1803 which is used for the shared logic is also the place 1801 where the documents comprising the document set are defined (i.e. using the component content controls). In other words, these are the same file.

The body of program instructions 118 could in principle implement the steps described above at any of three levels: (i) at the Microsoft Word API level; (ii) at the level of an API offering strongly typed access to the DOCX File Format; or (iii) at a lower-level XML API level (for example, DOM or SAX).

As described above, the Word Add-In Authoring embodiment is implemented primarily at the Microsoft Word API level, using VSTO.

It will be apparent to those skilled in the art, that an authoring tool could be developed which uses programming instructions 118 written at the level of an API offering strongly typed access to the DOCX File Format and linked to the library providing that API. For example, Plutext's Swing- and docx4j-based docx4all editor (http://www.docx4java.org/syn/docx4all/trunk/docx4all/) could be extended, or a system built around libopc (http://libopc.codeplex.com/) or Microsoft's OpenXML SDK (http://msdn.microsoft.com/en-us/library/office/bb448854.aspx). An authoring tool could also be developed which was written at the lower-level XML API level, but this would be more cumbersome and error-prone.

There is also the possibility of implementing an authoring tool based around the “cloud app model” described at http://blogs.office.com/b/office-next/archive/2012/08/08/a-new-and-enhanced-developer-experience-for-office-and-sharepoint.aspx. At this point in time it is unclear whether that model is expressive enough to support implementation of the steps described herein, however, it is likely that the model will be enhanced sufficiently at some point in the future to support such an implementation.

Recall from the description of background art that a document assembly system provides two distinct environments, the first being an authoring environment for creating and maintaining source documents, and the second being a runtime environment for generating a resulting instance document from a source document.

It is preferable that the run time environment for an interactive document assembly system communicate via the Internet with a user operating a web browser on computing device 106 as shown in the system 100 of FIG. 1, as this allows the user to interact with the system via a wide variety of computing devices.

Disclosed here is a system in which an MVC Form is used as the basis for user interaction. FIG. 3 provides an overview of the steps which occur when a user interacts with the system at run time to produce an instance document from a source document.

At 301, processing of a selected source document is initiated. This may occur as a result of a user choosing the source document from a menu, or clicking a link to the source document, or because the source document has been selected by for example, an expert system or a workflow system.

Focusing now on 302, first the content of an MVC Form is described. This will be created in the memory device 128 by part of the body of program instructions 132, and passed to the MVC Form sub-system, implemented either as part of the body of program instructions 132, or running on a separate computing device as described further below.

In the embodiment described herein (the XForms embodiment), the MVC Form technology used is XForms, since XForms is an open standard of which there are a number of commercial implementations. So the content of an XForm produced by the system is described. For the women and children source document example above, the system generates the XForm in Annexures F to H. Annexure F shows the document comprises an XForms model (xf:model element at lines 7 to 33 or thereabouts) and a presentation component (/html/body/xf:group, at lines 36 to 43). The Xforms model is shown in full in Annexure G; the presentation component is shown in full in Annexure H.

The XForms model shown in Annexure G includes elements: xf:instances (starting at line 5 and line 22 or thereabouts, respectively), xf:submission (at line 36), and xf:bind elements (lines 39 to 60).

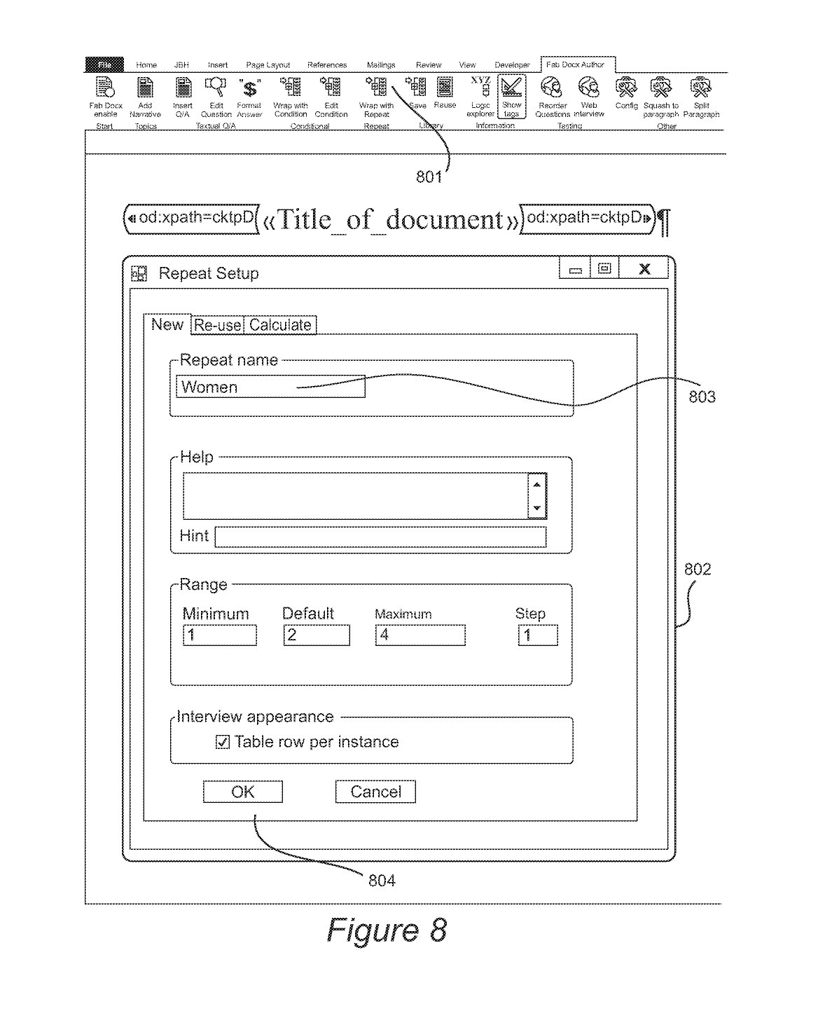

The xf:instance starting at line 5 simply contains the contents of the Answers Part. In this embodiment, the answer file is structured according to the schema in FIG. 8. However, it will become apparent to those skilled in the art that other structures could be used, provided there is a container for answers which vary with a region of repeating content in a source document (instances of the container should be siblings with the same element name), and that any answers associated with any nested repeats in that region are themselves in suitable descendant containers of the aforementioned containers.

The xf:submission element at line 37 specifies what is to happen when the user presses the submit button on the form.

An xf:bind element (lines 40 to 60) contains declarative expressions written in XPath which indicates when specific data in a model is needed, read only or relevant given the state of instance data elsewhere in the model. Such bind expressions are used in XForms documents that interact with the user—controlling the visibility of user interface controls on the screen, indicating error states, and ensuring all required fields are filled before form submission.

In this example, the source document was set up so that conditional upon whether a woman has any children, their names are to be provided. So the xf:bind element at line 40 in Annexure G says form controls associated with the nodeset given by XPath “/oda:answers/oda:repeat[qref=‘Women_wP’]/oda:row[index(‘Women_wF’)]/oda:repeat [@qref=‘children_tm’]/oda:row[index(‘children_tm’)]/oda:answer[@id=‘childs_name_Px’]” are only relevant if the condition “string(/oda:answers/oda:repeat[@qref=‘Women_wF’]/oda:row[1]/oda:answer[@id=‘Does_she_have_any_children_QF’])=‘true’” is satisfied. It also says the value provided for oda:answer[@id=‘childs_name_Px’] should be a string.

The presentation component shown in full in Annexure H defines the form controls to be presented to the user.

Notice that the xf:input, xf:select, and xf:repeat elements shown in Annexure H are in a one:one correspondence with the answers and repeats in the Answers Part in the xf:instance shown in Annexure G at lines 5 to 20.

The order elements appear in an xf:group typically matches the order in which they will be presented to the user. It is desirable to provide a way for the author of the source document to specify his/her preferred ordering. In this embodiment, this is done by providing a way to re-order the elements of the Answers Part using the authoring tool. Done this way, the ordering of those elements can be reflected in the xf:group. In alternative embodiments, elements are ordered in the xf:group according to a weighting allocated by the author, or by grouping them into topics (for which a preferred order can be specified).

Notice that there is an xf:repeat element (at lines 11 and 30 in Annexure H) corresponding to each oda:repeat/oda:row (lines 9 and 13 in Annexure G) in the Answers Part, and that the nesting relationship is preserved. The xf:trigger elements translate to widgets on the form which allow oda:row items to be added to (for example, Annexure H, line 37) or removed from (for example, Annexure H, line 46) the part of the model corresponding to the repeat.

Where an oda:row is to be added, the MVC Forms implementation needs a content template to populate it. If there is an existing oda:row, that row could be copied. XForms insert element has an attribute ‘origin’ which can be used to specify a template. To accommodate the case where the user has deleted or might delete all rows, it is convenient to have a separate instance (as shown in Annexure G at line 23) which contains a template oda:row for each repeat. If that instance was named ‘template’, the insert element might contain:

```
<xf:insert nodeset=“oda:row[index(‘children_tm’)]”
position=“after”
  origin=“instance(‘template’)/oda:repeat[@qref=‘Women_wF’]
    /oda:row[1]/oda:repeat[@qref=‘children_tm’]/oda:row”
  context=“/oda:answers/oda:repeat[@qref=‘Women_wF’]
              /oda:row[index(‘Women_wF’)]
            /oda:repeat[@qref=‘children_tm’]”/>
```

Finally, the xf:submit element (as shown in Annexure H at line 63) provides a submit button, which when pressed will cause the form to be submitted (305), at which point it is possible to generate an instance document from the source document using the XML data supplied from the form (307).

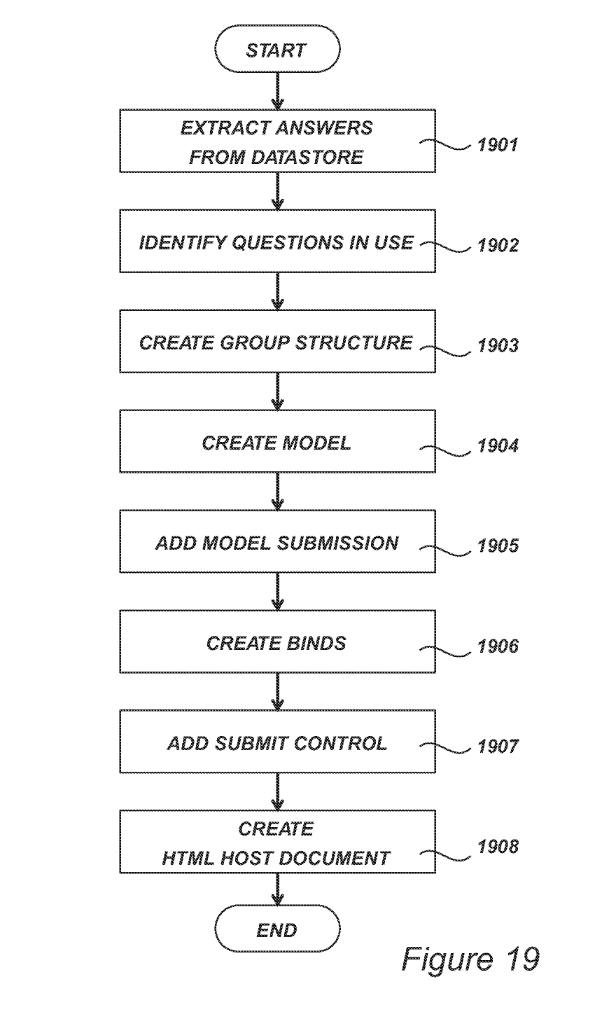

Having explained the content of the XForm produced by the system, explained next, with reference to FIG. 19, is the method by which it is produced (302). This method is implemented in software in the body of program instructions 132.

The Java package com.plutext contains a class CreateXForm. CreateXForm contains a method build, which takes as input a source document. This input is in the form of a docx4j WordprocessingMLPackage object.

At 1901, the Answers Part is extracted from the WordprocessingMLPackage object, and added to an xf:instance object (created using a JAXB representation of the XForms schema).

At 1903, the xf:group element structure is constructed, with a form control corresponding to each question and repeat. As a corresponding form control is only necessary if a question is actually used somewhere (i.e. directly to indirectly on a content control), a preliminary step 1902 is to identify the questions which are actually used in the logic attached to the content controls in the document.

In this embodiment, the xf:group element structure is constructed 1903 by walking the Answers Part, and converting each answer or repeat element encountered. An answer is converted to a select1 or input control as appropriate; a repeat is converted to an xf:repeat, plus appropriate xf:triggers. Where an answer varies in a repeat, the generated @ref needs to be made relative to that repeat (for example, Annexure H, line 33).

An alternative approach is to traverse the content controls in the document in document order, and add appropriate XForm controls as questions are encountered. This approach obviates the need to provide the author with a means to order the entries in the Answers Part (assuming document order is the order wanted), but is harder to get right (for example, because 2 repeat content controls, containing differing but non-contradictory logic, may use a single structure in the answer file).

At 1904, an xf:model object is created (using the JAXB representation of the XForms schema), and the xf:instance created earlier is attached. At 1905 a suitable xf:submission element is added.

At 1906, a class BindHelper generates the xf:bind elements. It does this by traversing the document, looking for usages of answers which are descendants of condition content controls. Note that XForms only allows one bind element per nodeset, so if a question is used in 2 different conditions the relevance of this question is expressed in a single bind (via a Boolean or). Notice also that if an xf:bind element is to refer to a nodeset which is in a repeat, the indexes in the XPath expression refer to that repeat, using an index( ) function. For example, index(‘Women_wF’) in the XPath expression oda:repeat[@qref=‘Women_w’]/oda:row[index(‘Women_wF’)].

It is desirable to specify whether the user must provide an answer to a particular question. In XForms, this is done by including @required on the relevant xf:bind. The authoring tool allows the author to set attribute @required (B01) which is flowed through to the xf:bind element.

Where the input expected from a user is a date, it is desirable to be able to seek this input using a calendar widget. Moreover, it is desirable to be able to insert the date in the document in various formats, for example “31^{st} of July 2012”, “Jul. 31, 2012” or “31/7/2012”.

This is achieved as follows. In the source document, a date content control is inserted by the authoring tool if the author indicates that a particular variable is of data type date (at 701). A date content control can have a format associated with it, so the authoring tool provides an interface for specifying this. When the XForm is generated, the date type is specified on the corresponding xf:bind element. This will generally cause an XForms implementation to display a calendar widget.

At 1907 an XForm submit control is added to the outermost xf:group, and finally, at 1908, the xf:model object and the outermost xf:group object are put into a suitable HTML container (refer Annexure F).

At this point the XForm is ready to be passed to the MVC sub-system for presentation to the user (303), although it could first be altered (either by hand or by code) to tailor its contents, if that were desired. The MVC sub-system presents the XForm to the user. As explained in the background art, a user may retrieve an XForm from a server, or other location, and load the XForm. In this scenario the XForms functionality is implemented as an XForms processor installed on the user's computer, e.g., within a client computer. For example, an XForms plug-in executable may be installed to execute within a Web browser on the user's computer. Alternatively, the XForms processor may be partially or wholly implemented server side, and the data gathered from the user in some other way (for example, using an HTML form).

At 304, the user fills in the form, and indicates that the form is complete, typically by pressing a “submit” button. Program instructions forming part of the MVC Forms sub-system generate and handle an xform-submit event 305, as specified in section 11.2 of the XForms 1.1 specification (http://www.w3.org/TR/xforms11/#submit-evt-submit). An MVC sub-system would generally perform validation 306, for example, checking that all mandatory fields have been completed, and that provided data conforms to any type restrictions (e.g. date, number). If valid, at 307, the answers are sent to the document assembly system.

At 308 the answers are received by the document assembly system. At 309, docx4j is used in this embodiment to create an instance document by combining the source document with the user's answers. This step is not explained further here, as a detailed procedure is embodied in package org.docx4j.model.datastorage in the source code of the docx4j open source project and readily available to interested parties.

Finally, at 310, something is done with the instance document. What this is outside the scope of this invention. Typically, the instance document will be streamed back to the user in DOCX File Format; docx4j can also be used to provide HTML and PDF renditions. In some systems the user will be required to pay before they are given access to the complete document. A system would also typically store the instance document server-side in the user's account, for later retrieval/modification. The answers can be saved as an Answers Part in the instance document; they can also be stored independently of the instance document, so that they can be used later as the basis for the creation of another or amended instance document. In order to do this, it is these answers which are added to the xf:instance.

The MVC sub-system can be loosely-coupled. In such an embodiment, the document assembly run-time can expose an interface (for example a SOAP or RESTful web service interface) allowing an independent software system having an MVC sub-system, to request the XForm (302) for a particular source document, present it to the user (303) for completion (304), submission (305 and 306) and, on receipt by this independent software system of the answers (307) it would submit the answers to the document assembly system (also 307), which on receipt (308), would generate an instance document (309) in response. In this arrangement, that independent software system intermediates between the user and the document assembly system.

It can be seen that the authoring tool disclosed herein, in conjunction with the method for generating an XForm disclosed herein, provides not just an effective way of creating a front end for a document assembly system's run time environment, but also a powerful approach for authoring an XForm.

Another way of looking at what has been achieved here, is a method for transforming the data model of an XForm into an instance document. A similar approach can be used to transform the data model of any MVC Form into an office document.

In the XForms embodiment described herein, the XForm model can be generated each time a user initiates the process to create an instance document from a source document. In an alternative embodiment, it could be generated once and associated with the source document (including by storing it in the source document as a Custom XML Part); this reduces processing, and, when the model is stored in the source document, lends itself to a processing model which does not require the ability to generate an XForm at that point in time.

Some questions result in the insertion of variable text; some questions determine whether conditional text is included or excluded. Another type of question is a repeat. Questions which determine whether conditional text is included or not, and repeats, are significant in the sense that they determine the ultimate structure of the instance document. Questions which result in the insertion of variable text do not affect the structure of the instance document in this way. It can be convenient to limit the interview process to questions which determine whether conditional text is included or not, and how many times the various repeating structures are to repeat. In an embodiment providing this feature, questions relating solely to variable text are excluded from the XForm; the user provides that data by typing directly into the instance document (in its DOCX File Format, or an HTML or PDF rendition).

Where a set of instance documents is to be created from a set of related source documents, it is desirable to generate a single MVC Form, so the user does not have to complete a separate form for each document. As previously explained, this can be achieved by having a single set of Custom XML Parts which are shared between the documents. In order to generate the xf:bind elements, the BindHelper class must traverse each of the related source documents, looking for usages of answers which are descendants of condition content controls.

In the XForms embodiment described herein, an XForms engine is used to present a suitable electronic form to the user. It is desirable to be able to present help, hints and commentary to the user. Help and hints can be provided using the XForms features so-named. In this document assembly system, commentary is provided by including content controls in the source document which are marked “narrative”. The contents of such content controls are converted for display in conjunction with the electronic form. In the example presented here (XForm in an XHTML host language), the content would be converted to XHTML (using docx4j in this embodiment). The content is placed in a div element with a class attribute, so that it can be styled using CSS. The Word document formatting can be carried across or ignored, depending on how the system is configured.

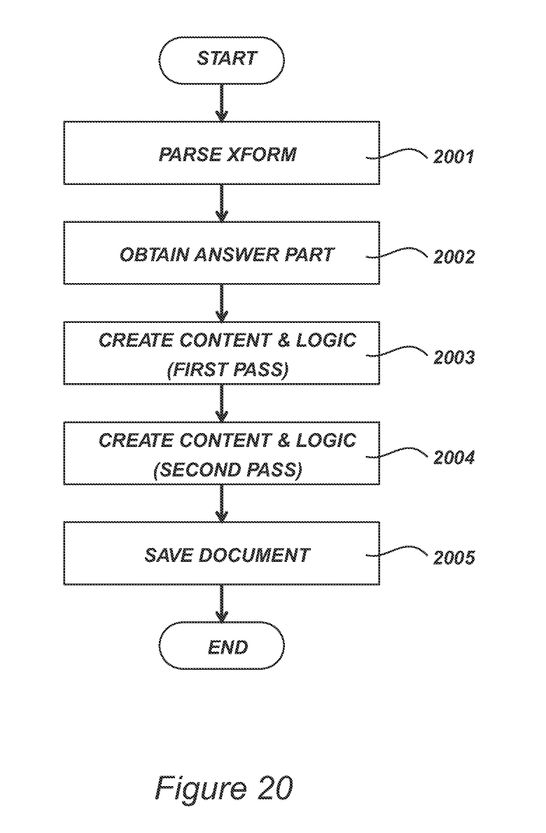

Next is described with reference to FIG. 20 a method for generating an initial version of a source document for a document assembly system from an MVC Form. The benefit of this is that an organisation that has an existing MVC Form or forms collection, but no corresponding document assembly source documents, does not have to start authoring from scratch (i.e. with empty Custom XML Parts) in creating a suitable source document.

In the embodiment described here, the MVC Form is an XForm, however, a similar procedure will work for the other types of MVC Forms. Consider again the sample XForm in XHTML shown in Annexures F to H. The objective is to generate from it, the necessary Custom XML Parts, namely: the Answers Part, the XPaths Part, the Questions Part, and the Conditions Part. It is also desirable to generate hierarchical content structures which use the variables and repeats in the XPaths Part, and the conditions in the Conditions Part, and to populate these with some placeholder text, so the author can start filling in the content without having to define questions/conditions/repeats, and adding associated content controls to the document; this is done for him/her.

The first step 2001 is to parse the XForm, or where XForm elements are embedded in a host document, parse the host document to find the XForm elements. This is straightforward using standard XML technologies, provided the input is well formed XML, or is made so (for example, by using a ‘tidy’ tool).

At this point an object representing an empty docx is created. A suitable library may be used to assist, such as docx4j, or Microsoft's Open XML SDK.

At 2002, an Answers Part is created, and populated with the content of the xf:instance, in this example:

<oda:answers xmlns=“http://opendope.org/answers”>
<oda:answer

id=“Title_of_document_nM”> [symbol] Title_of_document [symbol] </oda:answer>

```
  <oda:repeat qref=“Women_wF”>
    <oda:row>
      <oda:answer id=“Womans_name_LM”> [symbol]
      Womans_name [symbol]   </oda:answer>
      <oda:answer id=“Does_she_have_any_children_QF”>true
      </oda:answer>
      <oda:repeat qref=“children_tm”>
        <oda:row>
          <oda:answer id=“childs_name_Px”> [symbol]
          childs_name [symbol]   </oda:answer>
        </oda:row>
      </oda:repeat>
    </oda:row>
  </oda:repeat>
</oda:answers>
```

In the general case, the xf:instance data will be in an arbitrary XML format, rather than the Answer File format. In this case, the arbitrary XML is transformed into the Answer File format, and corresponding XPath expressions in bind elements and the xf:group altered to match. In an alternative embodiment, the arbitrary XML is inserted as is. In this alternative embodiment, the authoring tool would need to be able to handle an arbitrary answer format. As previously explained, the challenge this typically presents is how to avoid showing the author the XML (as this is intimidating for many authors). In this case, it is not so much of a problem, because questions are generated (see below) and will be available to be shown in the authoring user interface.

The Answers Part is then added to the docx object.

In the next step 2003, a main document part and the additional required Custom XML Parts are created. The main document part is populated with sample hierarchical content structure, which is obtained by traversing the xf:group (see Annexure H), not the xf:instance data (in Annexure G). The reason the xf:group is used, is that it provides useful information with which to populate the Questions Part and possible document content, as described below.

Xf:input and xf:select1 elements are converted to data bound content controls (the value of the ref attribute is used in the w:dataBinding element), and xf:repeat elements are converted to repeat content controls. Where xf:repeat, Xf:input and xf:select1 elements appear inside an xf:repeat, the resulting content controls are placed in the corresponding content control. References to content controls so created are maintained for following steps.

During this process, appropriate XPath part entries, and Question part entries, are created. When creating an XPath part entry for a repeat, the value of the nodeset attribute is used; when creating an XPath part entry from an xf:input or xf:select, the value of the ref attribute is used.

The question part entries are created using the xf:label values, and in the case of xf:select1, a fixed response (response/fixed) element is created with item children corresponding to each xf:item.

Any HTML text content which is encountered can be converted to DOCX File Format content using docx4j, and inserted into the document.

Conditions are generated (step 2004) by iterating over the xf:bind elements. Consider:

```
  <xf:bind type=“string”
nodeset=“/oda:answers/oda:repeat[@qref=‘Women_wF’]
  /oda:row[index(‘Women_wF’)]
  /oda:repeat[@qref=‘children_tm’]
    /oda:row[index(‘children_tm’)]
      /oda:answer[@id=‘childs_name_Px’]”
relevant=“string(/oda:answers/oda:repeat[@qref=‘Women_wF’]
      /oda:row[1]
/oda:answer[@id=‘Does_she_have_any_children_QF’])
=‘true’”
```

This says that within a content control for the nested Children repeat, the data bound content control which was inserted for the Child's name, should actually have been wrapped in a conditional content control, where the condition is given by the value of the “relevant” attribute:

relevant=“string(/oda:answers/oda:repeat[@qref=‘Women_wF’]
/oda:row[1]
/oda:answer[@id=‘Does_she_have_any_children_QF’])
=‘true’” />

So this alteration is made, and the corresponding condition added to the Conditions Part (which condition uses an XPath part entry, also added).

While traversing the xf:bind elements any data type values (given by the “type” attribute) identified are used to set the corresponding value in the appropriate XPath part entry.

Any xf:submission, xf:submit, or xf:trigger element encountered is ignored.

Finally, a Word document in docx format is saved from the docx object (2005).

After following this procedure, an initial version of the source document containing appropriate logic and suitable content controls, is available for the author to start working on. Program instructions implementing the above steps can be included as part of the body of programming instructions 118 and executed on the authoring machine 104, or included as part of the body of programming instructions 132 and executed on the server 108.

The embodiments have been described using custom xml data binding in the source document, and using XForms for the MVC Form. Both these elements rely on XML technologies. It will be apparent to those skilled in the art that the invention could be embodied using JSON instead of or in conjunction with XML technologies. For example, using JSON instead of XML data store content, using a JSON analog of XPath, and carrying this through to a JSON capable MVC Forms implementation as these become available.

What is claimed:

1. A method of creating a document assembly source document by an author using a document creation application, the method comprising the steps of:
providing one or more selection interface components within the document creation application, each selection interface component being operable by the author to create a variable content element within a current document;
receiving from the author a selection of one of the selection interface components;
presenting to the author one or more input components adapted for receipt of variable content configuration information associated with the selected one of the selection interface components;
receiving from the author values of the variable content configuration information;
creating document assembly source control elements corresponding with the variable content element and the variable control configuration information; and
associating the document assembly source control elements with the current document,
wherein the document assembly source elements are adapted for generation of a document assembly content form which comprises separate data model and presentation sections.

2. The method of claim 1 wherein the current document is an Office Open XML (OOXML) format document.

3. The method of claim 2 wherein the step of associating the document assembly source control elements with the current document comprises storing the document assembly source control elements within the current document.

4. The method of claim 3 wherein the document assembly source control elements comprise a question element within a questions part of the current document, an answer element within an answers part of the current document, and a path element within a paths part of the current document, wherein the path element associates the question element with the answer element.

5. The method of claim 4 wherein the variable content element comprises a condition, and the document assembly source control element further comprises a condition element within a condition part of the current document.

6. The method of claim 3 wherein the document assembly source control elements further comprise a document assembly logic element within a body of the current document, the document assembly logic element being associated with content stored in other document assembly source control elements.

7. The method of claim 6 wherein the document assembly logic element comprises a content control.

8. A non-transient computer-readable medium having a document assembly source document stored thereon, wherein the document assembly source document comprises:
a document body section containing one or more document assembly logic elements; and
one or more document assembly content sections containing content information associated with each of said one or more document assembly logic elements.

9. The medium of claim 8 wherein the document assembly source document is structured according to an Office Open XML (OOXML) format.

10. The medium of claim 9 wherein the document assembly logic elements are comprised in content regions of the document body section.

11. The medium of claim 10 wherein the document assembly content sections are comprised in custom XML parts of the document assembly source document.

12. The medium of claim 8 wherein the document assembly content sections comprise a questions part containing one or more question elements, an answers part containing one or more answer elements, and a path part containing one or more path elements associating the question elements with the answer elements.

13. The medium of claim 8 wherein the document assembly source document comprises reusable content.

14. The medium of claim 8 wherein the document assembly logic elements comprise repeating logic elements.

15. The medium of claim 14 wherein the repeating logic elements comprise nested repeating logic elements.

16. A method of generating a document assembly content form from a corresponding document assembly source document which comprises a document body section containing one or more document assembly logic elements, and one or more document assembly content sections containing content information associated with each of said one or more document assembly logic elements, the method comprising:
creating a data model form section based upon content information in the one or more document assembly content sections of the document assembly source document;
creating a presentation form section associated with the data model form section based upon document assembly logic elements in the document body section of the document assembly source document and content information in the one or more content sections of the document assembly source document; and
generating a document assembly content form comprising said data model section and said presentation section.

17. The method of claim 16 wherein the document assembly source document is structured according to the Office Open XML (OOXML) format.

18. The method of claim 16 wherein the document assembly content form comprises an XForm.

19. A method of generating a document assembly source document based upon a document assembly content form which comprises a data model section and a presentation section, the method comprising:
parsing the document assembly content form to extract presentation elements from the presentation section and content elements from the presentation section and the data model section;
generating, from the extracted presentation elements, one or more corresponding document assembly logic elements;
generating, from the extracted content elements one or more items of content information corresponding with the document assembly logic elements; and
generating a document assembly source document comprising a document body section containing the document assembly logic elements, and one or more document assembly content sections containing the content information associated with each of the document assembly logic elements.

20. The method of claim 19 wherein the document assembly content form comprises an XForm.

21. The method of claim 19 wherein the document assembly source document is structured according to the Office Open XML (OOXML) format.

22. An apparatus for creating a document assembly source document by an author, comprising:
a processor;
a memory operatively associated with the processor;
at least one input device for use by the author to interact with a document creation application comprising executable program instructions stored in the memory and executed by the processor; and
at least one output device enabling the document creation application to present information and interface elements to the author,
wherein the memory further comprises executable instructions which, when executed by the processor, cause the apparatus to execute a method comprising steps of:
presenting to the author, via the output device, one or more
selection interface components within the document creation application, each interface component being operable by the author to create a variable content element within a current document;
receiving from the author, via the at least one input device, a selection of one of the selection interface components;
presenting to the author, via the output device, one or more input interface components adapted for receipt of variable content configuration information associated with the selected one of the selection interface components;
receiving from the author, via the at least one input device, values of the variable control configuration information;
creating, within the memory, document assembly source control elements corresponding with the variable content element and the variable control configuration information; and
associating, in the memory, the document assembly source control elements with the current document,
wherein the document assembly source elements are adapted for generation of a document assembly content form which comprises separate data model and presentation sections.

23. An apparatus for generating a document assembly content form from a corresponding document assembly source document which comprises a document body section containing one or more document assembly logic elements, and one or more document assembly content sections containing content information associated with each of said one or more document assembly logic elements, the apparatus comprising:
a processor; and
a memory operatively associated with the processor,
wherein the memory comprises executable instructions which, when executed by the processor, cause the apparatus to execute a method comprising steps of:
creating, within the memory, a data model section based upon
content information in the one or more document assembly content sections of the document assembly source document;
creating, within the memory, a presentation section associated with the data model section, based upon document assembly logic elements in the document body section of the document assembly source document
and content information in the document assembly content section of the document assembly source document; and
generating, within the memory, a document assembly content form comprising said data model section and said presentation section.

24. An apparatus for generating a document assembly source document based upon a document assembly content form which comprises a data model section and a presentation section, the apparatus comprising:
a processor; and
a memory operatively associated with the processor,
wherein the memory comprises executable instructions which, when executed by the processor, cause the apparatus to execute a method comprising steps of:
parsing the document assembly content form to extract presentation elements from the presentation section and content elements from the presentation section and the data model section;
generating, within the memory, from the extracted presentation elements, one or more corresponding document assembly logic elements;
generating, within the memory, from the extracted content elements, one or more items of content information corresponding with the document assembly logic elements; and
generating, within the memory, a document assembly source document comprising a document body section containing the document assembly logic elements, and one or more document assembly content sections containing the content information associated with the document assembly logic elements.
